(19) United States
(12) Patent Application Publication
(10) Pub. No.: US 2025/0361573 A1
(43) Pub. Date: Nov. 27, 2025

(54) QUENCHING METHOD

(71) Applicant: AISIN CORPORATION, Kariya (JP)

(72) Inventors: Koji OBAYASHI, Kariya-shi (JP); Kazuaki OKADA, Kariya-shi (JP); Daisuke KASAI, Kariya-shi (JP); Keisuke MATSUZAKA, Kariya-shi (JP); Tadashi MIZUTANI, Kariya-shi (JP); Takeshi RYUJIN, Kariya-shi (JP); Toshiaki MATSUMURA, Kariya-shi (JP)

(73) Assignee: AISIN CORPORATION, Kariya (JP)

(21) Appl. No.: 19/198,406

(22) Filed: May 5, 2025

(30) Foreign Application Priority Data
May 24, 2024 (JP) 2024-084581
Jan. 21, 2025 (JP) 2025-008520

(51) Int. Cl. C21D 1/18; C09K 5/04; C21D 1/60

(52) U.S. Cl. CPC C21D 1/18; C09K 5/048; C21D 1/60; C21D 2211/008

(57) ABSTRACT

A quenching method of cooling an object to be treated placed on a support base, including a lowering control step controlling the support base to be lowered into a coolant accumulated in a state of the coolant not flowing in a cooling tank and having a maximum value of a surface heat transfer coefficient in a boiling stage of 6000 W/m²·K or more, and immersion of the object is completed and the support base is stopped while a vapor film of the coolant is formed around the object by heat of the object, and a state maintaining step in which the coolant is not flowed and the support base does not move so that no relative flow is applied between the object and the coolant until a surface of the object undergoes martensite transformation after the support base is stopped.

### CROSS REFERENCE TO RELATED APPLICATIONS

This application is based on and claims priority under 35 U.S.C. § 119 to Japanese Patent Application Nos. 2025-008520 and 2024-084581, respectively filed on Jan. 21, 2025 and May 24, 2024, the entire contents of which are incorporated herein by reference.

### TECHNICAL FIELD

The present disclosure relates to a quenching method.

### BACKGROUND DISCUSSION

In the related art, there is known a technique for controlling a relative speed between an object to be treated and a coolant around the object to be treated when quenching is performed using water having a high cooling capacity as a coolant. For example, JP 2002-97520 A discloses a configuration in which an object to be treated is immersed in a refrigerant having a flow velocity of 1.0 m/sec or more, so that the entire surface is cooled from a boiling stage without forming a vapor film stage.

WO 2020-203226 A discloses a configuration in which, when an object to be treated is moved into an aqueous coolant and quenched, a relative speed between the object to be treated and the coolant is made slower than a moving speed of the object to be treated at least until the object to be treated undergoes martensite transformation. JP 2021-147626 A discloses a configuration in which, in a quenching method in which a metal member is immersed in heat treatment oil and quenched, the metal member is lowered in the heat treatment oil, and the metal member is stopped when it is in a vapor film stage in which an oil sinking start portion, which is a portion that first sinks in the heat treatment oil, is covered with a vapor film and then raised.

In addition, JP 2023-153496 A discloses a configuration in which an object to be quenched is immersed in a state of being hung on a bar body and a vapor film is actively peeled off from the object to be quenched in order to suppress an influence of the vapor film on a result of quenching.

When quenching that requires internal hardness of an object to be treated or a depth of a cured layer is performed, it is necessary to rapidly cool the object to be treated to increase a cooling rate of the inside of the object to be treated, and thus, various kinds of coolants having high cooling capacity are used. However, when a coolant having a high cooling capacity is used, distortion remains after quenching unless there is no difference in cooling rate for each location of the object to be treated.

For example, in the technique disclosed in JP 2002-97520 A, by applying a large flow velocity to the coolant, the entire surface is cooled from the boiling stage without forming the vapor film stage. However, in JP 2002-97520 A, a suction mechanism for applying a flow velocity to water is operated until cooling of a treated product is completed. Therefore, even after the transition from the vapor film stage to the boiling stage, the flow velocity is given to the coolant until the cooling is completed. Further, in the technique disclosed in JP 2002-97520 A, a flow velocity from the top to the bottom of the treated product is given. In this case, the coolant accumulates in the lower part of the treated product and the flow velocity relative to the treated product is small, and the coolant is stirred to increase the flow velocity relative to the treated product on the upper part of the treated product. Therefore, the upper part of the treated product is cooled at a higher speed than the lower part. For this reason, there is a difference in cooling rate until martensite transformation occurs between the upper part and the lower part of the treated product, and distortion occurs in the treated product after completion of quenching.

On the other hand, according to the technique disclosed in WO 2020-203226 A, since the relative speed between the object to be treated and the coolant is slower than the moving speed of the object to be treated, the cooling speed is made uniform in the vertical direction of the object to be treated. However, WO 2020-203226 A has a configured so that the relative speed between the object to be treated and the coolant is slower than the moving speed of the object to be treated by lowering the object to be treated until martensite transformation occurs and causing the coolant to flow downward. Therefore, in order to maintain a state in which the relative speed is low until martensite transformation occurs, it is necessary to deeply move the object to be treated downward, and a deep cooling tank is required.

Further, in JP 2021-147626 A, it is necessary to lower and further raise the metal member in the cooling tank to complete quenching in the process of the raising. For this reason, a relative flow velocity is generated between the treated product and the coolant before the martensite transformation occurs, and distortion occurs in the treated product after completion of quenching. In addition, a cooling tank having a very deep stroke amount of 100 to 700 m or the like, which is a descending depth, is required.

In JP 2023-153496 A, a vapor film is peeled off as soon as possible by holding an object to be quenched in an unstable state, and it does not disclose an idea that the vapor film is actively used.

The present disclosure has been made in view of the above problems, and an object of the present disclosure is to reduce a difference in cooling rate in the vertical direction and reduce heat treatment deformation without requiring a deep cooling tank.

### SUMMARY

A quenching method of cooling an object to be treated placed on a support base, the quenching method includes a lowering control step of controlling the support base so that the support base is lowered into a coolant accumulated in a state of the coolant not flowing in a cooling tank and having a maximum value of a surface heat transfer coefficient in a boiling stage of 6000 W/m²·K or more, and immersion of the object to be treated is completed and the support base is stopped while a vapor film of the coolant is formed around the object to be treated by heat of the object to be treated, and a state maintaining step of maintaining a state in which the coolant is not flowed and a state in which the support base does not move so that a relative flow velocity is not applied between the object to be treated and the coolant at least until a surface of the object to be treated undergoes martensite transformation after the lowering of the support base is stopped.

### BRIEF DESCRIPTION OF THE DRAWINGS

The foregoing and additional features and characteristics of this disclosure will become more apparent from the following detailed description considered with the reference to the accompanying drawings, wherein:

FIG. 1A is a diagram schematically illustrating a device for implementing a quenching method, and FIG. 1B is a diagram illustrating a state during quenching;

FIG. 2 is a flowchart illustrating a heat treatment step;

FIG. 3 is a diagram for describing a stroke;

FIG. 4 is a diagram illustrating a surface heat transfer coefficient of a coolant;

FIG. 5 is a diagram for describing an effect;

FIG. 6 is a diagram illustrating a temperature change and a martensite fraction of an object to be treated according to Example 1;

FIG. 7 is a diagram illustrating an amount of distortion of an object to be treated according to Example 1;

FIG. 8 is a diagram illustrating a temperature change and a martensite fraction of an object to be treated according to Comparative Example 1;

FIG. 9 is a diagram illustrating an amount of distortion of an object to be treated according to Comparative Example 1;

FIG. 10 is a diagram illustrating an amount of distortion, an amount of elongation, and internal hardness of objects to be treated according to Example 1 and Comparative Example 1;

FIG. 11 is a diagram illustrating hardness of objects to be treated according to Example 1 and Comparative Example 2;

FIG. 12 is a diagram illustrating a temperature change and a martensite fraction of an object to be treated according to Example 2;

FIG. 13 is a diagram illustrating an amount of distortion of an object to be treated according to Example 2;

FIG. 14 is a diagram illustrating a temperature change and a martensite fraction of an object to be treated according to Example 3;

FIG. 15 is a diagram illustrating an amount of distortion of an object to be treated according to Example 3;

FIG. 16 is a diagram illustrating an amount of distortion, an amount of elongation, and internal hardness of objects to be treated according to Example 2 and Example 3;

FIG. 17 is a diagram illustrating an Example in a case where an object to be treated S is placed at each of a plurality of different positions in the vertical direction;

FIGS. 18A and 18B are diagrams illustrating a configuration of a ring gear as an object to be treated, and FIGS. 18C and 18D are diagrams illustrating a configuration of a drive shaft as an object to be treated;

FIG. 19 is a diagram illustrating an example of a support base when a ring gear is immersed;

FIG. 20 is a schematic diagram for describing, for each part, a period during which a vapor film is maintained when a drive shaft is immersed;

FIG. 21 is a diagram illustrating a state in which immersion is completed in a case where a drive shaft is used as an object to be treated;

FIG. 22 is a diagram illustrating an Example in a case where a drive shaft as an object to be treated is placed at each of a plurality of different positions in the vertical direction of a support base;

FIG. 23 is a diagram illustrating an example of a support base when a drive shaft is immersed; and

FIG. 24 is a diagram illustrating a state in which an insertion portion for inserting one drive shaft and a coupling portion 211c are viewed in a center axis Ax direction of the drive shaft.

### DETAILED DESCRIPTION

Here, embodiments of the present disclosure will be described in the following order.
(1) Configuration of device implementing quenching method:
(2) Heat treatment step:
(3) Examples:
(4) Other embodiments:

### (1) Configuration of Device Implementing Quenching Method

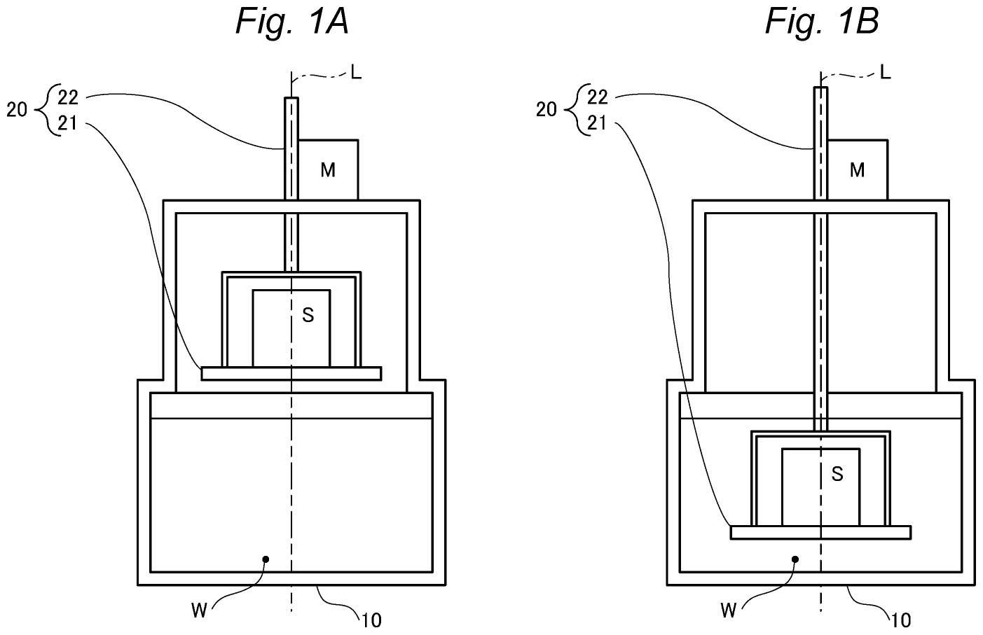

FIG. 1A is a diagram schematically illustrating a device that implements a quenching method according to an embodiment of the present disclosure. FIG. 1A illustrates a main part of the device, and various configurations can be used as a mechanism for driving each part, a shape of each part, and the like. In the device illustrated in FIG. 1A, a cooling tank 10 having a rectangular parallelepiped hollow portion is provided. In the present embodiment, a coolant Wis accumulated in the cooling tank 10 in advance. In the present embodiment, the coolant Wis a liquid in which a vapor film is generated around an object to be treated S after the object to be treated S to be quenched is immersed, and the vapor film is maintained at least until the immersion of the object to be treated S is completed. A specific example of the coolant W will be described later.

In the present embodiment, the device that implements the quenching method includes a moving device 20 that moves the object to be treated S up and down. The moving device 20 includes a support base 21 and a support portion 22, and the object to be treated S is placed on the support base 21. The support portion 22 includes a portion extending in the vertical direction, and a lower end portion of the portion is connected to the support base 21. A motor M is connected to the support portion 22, and the support base 21 can be moved up and down by converting the rotational force of the motor M into the elevating motion of the support portion 22 by a mechanism (not illustrated).

The configuration for moving the support portion 22 in the vertical direction may be various configurations, and the drive source of the motor M may be various energies. Further, the support portion 22 may be moved up and down by various mechanisms such as electric, hydraulic driving, and atmospheric pressure driving. The mode of the motor M is not limited, and may be a linear motor or the like.

In the present embodiment, the motor M can change the elevating speed of the support base 21 on which the object to be treated S is placed, and can designate the lifting speed of the support base 21 and the lowering speed of the support base 21 by a control signal output from the control device to the motor M.

The number of objects to be treated S to be placed on the support base 21, the way (orientation) in which the objects to be treated S are placed, and the like may be in various modes. For example, a pallet may be attached to the support base 21, and a plurality of objects to be treated S may be disposed in the pallet. In the present specification, a case where there is one object to be treated S will be described as an example. Of course, the support base 21, the support portion 22, and the like may have various features, and for example, the support base 21 may be formed in a mesh or lattice shape in order to easily lower the support base 21.

In the present embodiment, the object to be treated S is a component after carburization treatment. The carburization treatment may be performed by a carburization treatment device (not illustrated in FIG. 1A), and the object to be treated S may be heated by a furnace having various modes to carburize the object to be treated S with carbon present around the object to be treated S. Of course, the configuration of the furnace is not limited, and the object to be treated S may be conveyed while being carburized in the furnace, or may be taken out after carburization is performed on the object to be treated S existing at a fixed position in the furnace. The mode of carburization is not limited, and carburization may be performed in various modes such as gas carburization, liquid carburization, solid carburization, vacuum carburization (vacuum gas carburization), and plasma carburization. In any case, the object to be treated S after carburization may be set on the support base 21 and quenched.

### (2) Heat Treatment Step

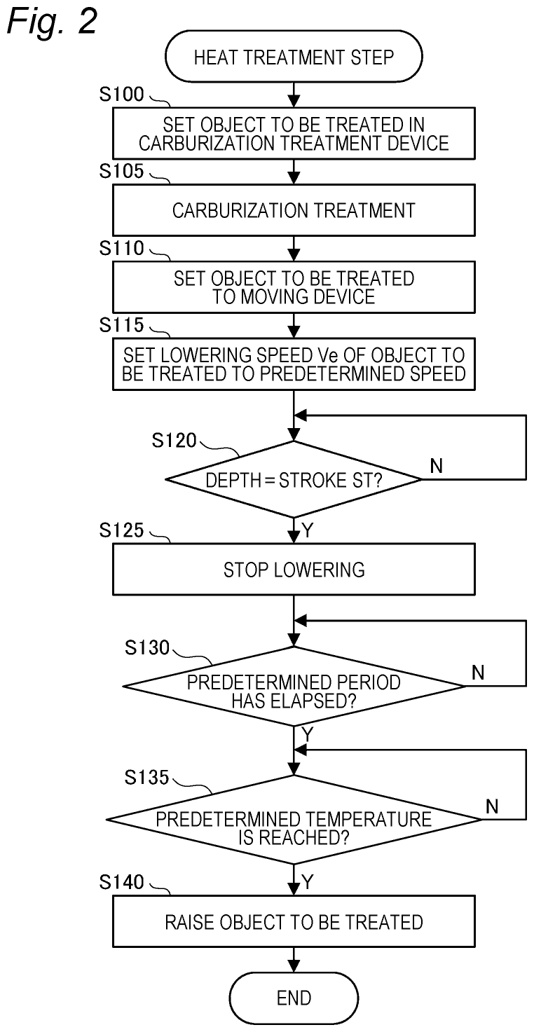

Next, the heat treatment step (carburization treatment and quenching treatment) for the object to be treated S will be described. FIG. 2 is a flowchart illustrating a heat treatment step according to the present embodiment. In the heat treatment step, the object to be treated S to be heat-treated is set in the carburization treatment device (step S100). Next, a carburization treatment is performed (step S105). The conditions for the carburization treatment are determined based on the purpose of use of the object to be treated S and the like. For example, a predetermined carbon-containing material (gas or the like) is introduced into a carburization treatment device in which the object to be treated S is set, and the object to be treated S is heated to a target temperature at a predetermined temperature rise rate. When the object to be treated S reaches the target temperature, the temperature is maintained at the target temperature for a predetermined period.

Next, the object to be treated S subjected to the carburization treatment is set in the moving device 20 (step S110). That is, the object to be treated S subjected to the carburization treatment is placed on the support base 21. In the present embodiment, since the cooling tank 10 does not include a device for causing the coolant W therein to flow, the coolant W does not flow in the cooling tank 10.

Next, a lowering speed Ve of the object to be treated is set to a predetermined speed (step S115). That is, a control signal is output to the motor M, and as a result, the lowering speed Ve of the support base 21 is a predetermined speed, and the lowering of the support base 21 is started. The predetermined speed is set so that the immersion of the object to be treated S is completed while the vapor film of the coolant W is formed around the object to be treated S by the heat of the object to be treated S.

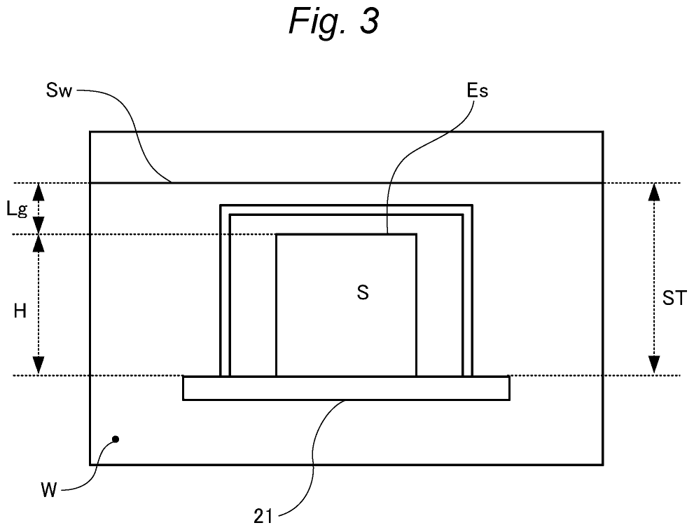

A state in which the upper end of the object to be treated S is below the liquid level of the coolant W is an immersion completion state. In the present embodiment, as illustrated in FIG. 3, a stroke ST is determined so that an upper end Es of the object to be treated S is lower than a liquid level Sw of the coolant W by the predetermined distance Lg. That is, the stroke ST is set so that the distance Lg between the upper end Es of the object to be treated S and the liquid level Sw of the coolant W is larger than 0. Note that it is not necessary to excessively increase the distance Lg, and the distance Lg may be the minimum necessary length. That is, the distance Lg may be set so that when the object to be treated S is not exposed to the outside of the coolant W, the lowering of the object to be treated S is stopped, and the uppermost portion of the object to be treated S is cooled at the position of the distance Lg from the liquid level Sw, the vapor film may be stably generated, and the coolant W covers the object to be treated S even in the boiling stage after the vapor film disappears. Specifically, the distance Lg can be set to a maximum waviness length (height)+30 mm or the like. The distance Lg may be set to one time or less, ½ or the like of the total height of the object to be treated S.

The lowering speed Ve may be set so that the immersion of the object to be treated S is completed while the vapor film of the coolant W is formed around the object to be treated S, and may be set in accordance with the height H of the object to be treated S, the characteristics of the coolant W, and the like. Specifically, in the present embodiment, the object to be treated S descends until the distance (Lg+H) from the liquid level Sw of the coolant W to the lower end of the object to be treated S at the descending stop position of the support base 21 matches the stroke ST. The lowering speed Ve is set to be faster than (stroke ST/vapor film maintaining period T around object to be treated S). When the speed is set in such a way, the immersion of the object to be treated S can be completed before the vapor film disappears.

Assuming that the vapor film maintaining period T is the same between at the portion immersed first and at the portion immersed last of the object to be treated S, the difference between the timing at which the vapor film disappears at the portion immersed first and the timing at which the vapor film disappears at the portion immersed last is equivalent to the difference between the timings at which both portions are immersed at most. Therefore, in order to reduce the difference in the timing at which the vapor film disappears between at the portion immersed first and at the portion immersed last, it is preferable to move the support base 21 as fast as possible within the vapor film maintaining period T after the immersion of the first portion.

Therefore, (the stroke ST/the vapor film maintaining period T of the object to be treated S) is the lower limit value of the lowering speed Ve, and the lowering speed Ve is set to a value larger than ST/T. For example, in a case where a cylindrical object to be treated S that is the SCM420 obtained by carburizing the material and has a height of 36 mm is immersed in a 20% water-soluble coolant at a stroke ST of 520 mm, a lowering speed Ve of 400 mm/sec or the like can be employed.

The vapor film maintaining period T is a period in which the vapor film is formed. In the present embodiment, the vapor film maintaining period T is a period from the start of immersion of the portion immersed first of the object to be treated S until the vapor film disappears around the portion and boiling starts. The vapor film is formed by transferring heat of the object to be treated S to the coolant W to vaporize the coolant W, and the vaporized coolant W existing between the surface of the object to be treated S and the liquid coolant W.

The state in which the vapor film exists around the object to be treated S is a state in which the vapor film exists over the entire outer face of the object to be treated S. In the present embodiment, the state in which the vapor film exists around the object to be treated S is assumed to be a state in which the vapor film exists over the entire outer face of the object to be treated S. However, it is not excluded that the vapor film locally and temporarily disappears on the outer face of the object to be treated S. That is, even when a state in which vapor does not temporarily exist occurs in a small part of the outer face of the object to be treated S, when a state in which vapor locally disappears does not continue, it may be considered that a vapor film exists.

In the state where the vapor film of the coolant W is in contact with the outer face of the object to be treated S, the surface heat transfer coefficient (heat transfer amount per unit area and unit difference in temperature) is smaller than that in the state where the liquid of the coolant W is in contact with the outer face. Therefore, the vapor film maintaining period T is a period in which the change per unit temperature of the surface heat transfer coefficient between the coolant W and the object to be treated S is equal to or less than the predetermined value in the state where the object to be treated S is immersed in the coolant W. The surface heat transfer coefficient is defined in JIS Z8000-5:2014 “Amount and Unit-Part 5: Thermodynamics”, and is defined as a surface heat transfer coefficient α=Q/(A(Tw−Ta)). Where, Q is a heat transfer amount (W), A is a heat transfer area (m²), Tw is a surface temperature (K) of the object to be treated S, and Ta is a coolant temperature (K).

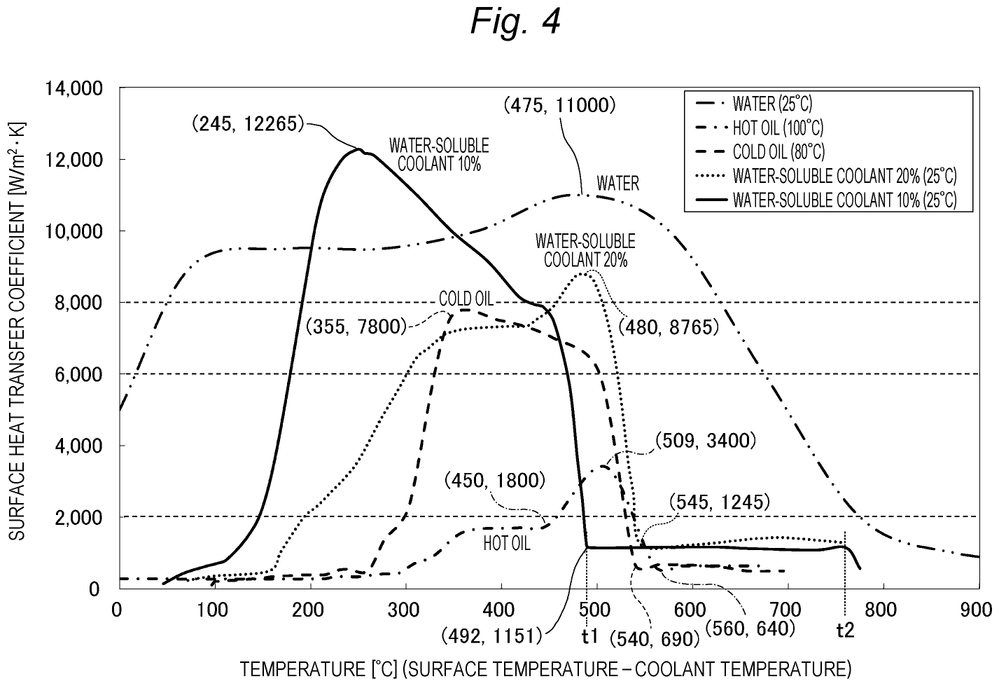

FIG. 4 is a diagram illustrating a surface heat transfer coefficient of the coolant W. In FIG. 4, the horizontal axis represents the temperature (the surface temperature of the object to be treated S—the coolant temperature: ° C.), and the vertical axis represents the surface heat transfer coefficient, and the surface heat transfer coefficient is indicated for each of the plurality of coolants W. The temperature of the coolant W can be set to various temperatures, and the surface heat transfer coefficient changes depending on the temperature of the coolant W. Therefore, the difference between the surface temperature of the object to be treated S and the temperature of the coolant W is taken as the temperature of the horizontal axis. The solid line indicates a water-soluble coolant in which 10% of the polymer compound is dissolved in water, the broken line indicated by the arrangement of dots indicates a water-soluble coolant in which 20% of the polymer compound is dissolved in water, the one-dot chain line indicates hot oil, the broken line indicated by the arrangement of lines indicates cold oil, and the two-dot chain line indicates water. In FIG. 4, the water-soluble coolant and water are at 25° C., the cold oil is at 80° C., and the hot oil is at 100° C. In FIG. 4, values of the temperature and the surface heat transfer coefficient are illustrated for a plurality of points on the curve. The surface heat transfer coefficient of the coolant W is calculated from a cooling curve obtained in accordance with the cooling performance test method of JIS K2242:2012 “Heat treatment oil agent”.

The water-soluble coolant is a coolant W in a state in which a water-soluble substance is dissolved in water, and is, for example, a polymer-based water-soluble coolant in which polyalkylene glycol, polyvinyl alcohol, polyethylene glycol, sodium polyacrylate, polyvinylpyrrolidone, or the like, which is a polymer compound (polymer), is dissolved. A polymer based water-soluble coolant in which at least one of these is dissolved may be used. The coolant W according to the present embodiment includes a water-soluble coolant containing a polyalkylene glycol as a main component. The concentration of the polymer compound is, for example, 5 to 30 vol %, 10 to 30 vol %, 10 to 20 vol %, or the like. Examples of the water-soluble coolant include Daphne Plastic Quench DQ (registered trademark) manufactured by Idemitsu Kosan Co., Ltd.

Examples of the hot oil and the cold oil include quench oil obtained by adding various additives to mineral oil. Examples of the hot oil include Shiny Martemper Oil S (registered trademark) manufactured by NIPPON GREASE Co., Ltd. in which an additive is added to a low-sulfur fine mineral oil as a base oil. Examples of the cold oil include Daphne Master quench A (registered trademark) manufactured by Idemitsu Kosan Co., Ltd. in which an additive is added to a paraffinic mineral oil as a base oil.

According to FIG. 4, it can be seen that a vapor film is formed when the object to be treated S that is austenitic at a higher temperature than the A1 transformation line in the steel state diagram is immersed. For example, in a 10% water-soluble coolant, the surface heat transfer coefficient has a substantially constant value over the temperature t1 to t2. The surface heat transfer coefficient of the constant value is smaller than the surface heat transfer coefficient in most of the range of the temperature equal to or lower than the temperature t1. As described above, the state in which the surface heat transfer coefficient is substantially constant is a state in which the vapor film is formed around the object to be treated S, so that heat is less likely to be transferred from the object to be treated S to the coolant W than when the periphery of the object to be treated S is a liquid. That is, in a temperature zone in which the surface heat transfer coefficient is substantially constant, the object to be treated S and the coolant W exchange heat with each other through the vapor film of gas, and thus the surface heat transfer coefficient is smaller than that in a state in which the object to be treated S and the coolant W in liquid exchange heat with each other.

In a temperature zone where the surface heat transfer coefficient is substantially constant, as illustrated in FIG. 4, the surface heat transfer coefficient is preferably 2000 W/m²·K or less. More preferably, the surface heat transfer coefficient is 1300 W/m²·K or less. Furthermore, in a temperature zone in which the surface heat transfer coefficient is substantially constant, the range in which the surface heat transfer coefficient changes is 1080 to 1164 W/m²·K in the water-soluble coolant in which 10% of the polymer compound is dissolved, and 1245 to 1285 W/m²·K in the water-soluble coolant in which 20% of the polymer compound is dissolved. In addition, the heat resistance is almost constant at 640 W/m²·K in hot oil, 500 to 680 W/m²·K in cold oil, and 800 to 1000 W/m²·K in water. As described above, it is possible to adopt the coolant W having a change range of about 200 W/m²·K, preferably 100 W/m²·K or less, more preferably 70 W/m²·K or less, and 40 W/m²·K or less in a temperature zone where the surface heat transfer coefficient is substantially constant.

When the surface heat transfer coefficient of the coolant W illustrated in FIG. 4 is observed, it is possible to identify whether a vapor film is formed around the object to be treated S when the object to be treated S is immersed. For example, when the object to be treated S for which carburization has been completed at a target temperature of about 850° C. is immersed in a 10% water-soluble coolant, cooling is started to form a vapor film, but the vapor film is maintained until the temperature of the object to be treated S reaches t1. When the object to be treated S reaches the temperature t1, the vapor film disappears, and the periphery of the object to be treated S is covered with the liquid coolant W.

As described above, during the period in which the vapor film is formed, the surface heat transfer coefficient is relatively small and does not change significantly. That is, the amount of change of the surface heat transfer coefficient with respect to the amount of decrease in temperature in the process in which the object to be treated S is immersed in the coolant W and the temperature decreases is equal to or less than the predetermined value. For example, it is possible to assume an example in which the change in the surface heat transfer coefficient per 10° C. is 100 W/m²·K or less. Of course, the predetermined value is an example, and a value so that a change in surface heat transfer coefficient per 10° C. is 80 W/m²·K or less, 50 W/m²·K or less, or 20 W/m²·K or less may be used.

The state in which the amount of change in the surface heat transfer coefficient with respect to the amount of decrease in temperature is equal to or less than the predetermined value is maintained between the temperature t2 at which the vapor film is formed immediately after the start of immersion and the temperature t1. When the temperature is lower than the temperature t1, the amount of change in the surface heat transfer coefficient with respect to the amount of decrease in temperature rapidly increases. That is, the predetermined value is exceeded. Therefore, the vapor film maintaining period T is a period from when the amount of change of the surface heat transfer coefficient with respect to the amount of decrease in temperature is a predetermined value or less first until the amount of change exceeds the predetermined value. The vapor film maintaining period T is identified by, for example, an experiment, a simulation, or the like.

As described above, in the vapor film stage, the surface heat transfer coefficient has a substantially constant value, but when the vapor film maintaining period T ends and the process shifts to the boiling stage, the surface heat transfer coefficient preferably has a large value. In the present disclosure, by using the coolant W in which the maximum value of the surface heat transfer coefficient in the boiling stage is 6000 W/m²·K or more, the object to be treated S is cooled at a high rate, the cooling rate of the inside of the object to be treated S can be increased, and the internal hardness and the depth of the cured layer of the object to be treated S can be secured. Specifically, since the surface heat transfer coefficient is 2000 W/m²·K or less in the vapor film stage, the amount of heat transferred from the object to be treated S to the coolant W is suppressed as compared with that in the boiling stage. On the other hand, when the maximum value of the surface heat transfer coefficient is 6000 W/m²·K or more in the boiling stage, the surface heat transfer coefficient changes by at least 4000 W/m²·K between the vapor film stage and the boiling stage. Therefore, when shifting to the boiling stage, a large amount of heat can be transferred from the object to be treated S to the coolant W. Note that the hot oil illustrated in FIG. 4 is excluded from the present disclosure.

Further, in the present embodiment, it is necessary to complete the immersion of the object to be treated S within the vapor film maintaining period T and stop the support base 21. Therefore, it is preferable that the vapor film maintaining period T is not excessively short, and the vapor film is formed over a certain period of time. Specifically, the boiling start temperature at which the vapor film formed around the object to be treated S disappears and boiling starts o is preferably 600° C. or lower. The boiling start temperature is also evaluated by the surface temperature of the object to be treated S-coolant temperature as in the temperature on the horizontal axis in FIG. 4. For example, when the coolant temperature is 25° C., the boiling start temperature of 600° C. means that the process shifts to the boiling stage when the surface temperature of the object to be treated S is 625° C.

When the coolant W having a boiling start temperature of 600° C. or lower is used and immersion is started in a state where the surface temperature of the object to be treated S is about 800° C., the vapor film is maintained until the object to be treated S is cooled by about 175° C. Therefore, the immersion of the object to be treated S can be completed during the vapor film maintaining period T without moving the object to be treated S at an excessively high speed. Further, even when the length of the object to be treated S in the vertical direction is long or when the object to be treated S is placed at each of a plurality of different positions in the vertical direction of the support base, the immersion of the object to be treated S can be completed during the vapor film maintaining period T.

When the boiling start temperature is 600° C. or lower, the immersion of the object to be treated S can be completed during the vapor film maintaining period T. Examples of such a coolant W include a 10% water-soluble coolant (boiling start temperature: 492° C.), a 20% water-soluble coolant (boiling start temperature: 545° C.), cold oil (boiling start temperature: 540° C.), and hot oil (boiling start temperature: 560° C.) illustrated in FIG. 4. When the coolant W having a boiling start temperature of 600° C. or lower is employed, the water illustrated in FIG. 4 is excluded.

Further, in the present embodiment, when the vapor film is maintained for an excessively long period, rapid cooling cannot be performed, and therefore it is preferable that the boiling start temperature is not excessively low. Therefore, for example, considering that the martensite transformation temperature of the base material is about 420° C., the boiling start temperature is preferably 450° C. or higher.

Further, in order to rapidly cool the object to be treated S by the coolant W in the boiling stage, it is preferable to rapidly cool the object to be treated S immediately after the transition from the vapor film stage to the boiling stage. For example, the rate of increase in the surface heat transfer coefficient per unit temperature decrease after the vapor film formed around the object to be treated disappears and boiling starts is preferably 100 W/m²·K² or more.

More specifically, by shifting from the vapor film stage to the boiling stage, heat is more efficiently transferred from the surface of the object to be treated S to the coolant W in the boiling stage than in the vapor film stage, so that the surface heat transfer coefficient rapidly increases immediately after shifting to the boiling stage. This degree can be evaluated by the rate of increase in the surface heat transfer coefficient per unit temperature decrease in the temperature decreasing process. It has been found that when the rate of increase is 100 W/m²·K² or more, rapid cooling can be performed at a sufficient speed in the boiling stage.

When the rate of increase in a surface heat transfer coefficient per unit temperature decrease is 100 W/m²·K² or more, the object to be treated S can be rapidly cooled in the boiling stage. Examples of such a coolant W include a 10% water-soluble coolant (rate of increase: 121 W/m²·K²), a 20% water-soluble coolant (rate of increase: 170 W/m²·K²), and cold oil (rate of increase: 144 W/m²·K²) illustrated in FIG. 4. When the coolant W having a rate of increase of 100 W/m²·K² or more is employed, water and hot oil illustrated in FIG. 4 are excluded.

In the case of the 10% water-soluble coolant, the 20% water-soluble coolant, and the cold oil illustrated in FIG. 4, immediately after the transition from the vapor film stage to the boiling stage, the rate of increase in the surface heat transfer coefficient per unit temperature decrease is 100 W/m²·K² or more, and the surface heat transfer coefficient is 6000 W/m²·K or more by increasing at the rate of increase. Therefore, these coolants W rapidly cool the object to be treated S in the boiling stage, and the state in which the surface heat transfer coefficient is 6000 W/m²·K or more is continued until the martensite transformation sufficiently proceeds (for example, until the temperature reaches 300° C. or lower). Therefore, the object to be treated S can be efficiently cooled.

The description returns to the flowchart illustrated in FIG. 2. When the lowering speed Ve is set to a predetermined speed in step S115, it is determined whether the depth of the lower end of the object to be treated S has reached the stroke ST (step S120). That is, it is determined whether the distance from the liquid level Sw of the coolant W to the position of the lower end of the object to be treated S matches the stroke ST. The determination can be realized by various configurations, and for example, the determination may be made based on detection results by various sensors, the drive time of the motor M, and the like.

As described above, in the present embodiment, the lowering speed Ve is set to the predetermined speed in step S115, and the object to be treated S is lowered until the depth of the lower end of the object to be treated S reaches the stroke ST in step S120. Therefore, in steps S115 and S120, the object to be treated S is lowered into the coolant W accumulated in the cooling tank 10, and the immersion of the object to be treated S can be completed while the vapor film of the coolant W is formed around the object to be treated S by the heat of the object to be treated S. When the immersion step of immersing the object to be treated S in the coolant W that does not flow in the cooling tank 10 is performed as in the present embodiment, a relative flow velocity always occurs between the object to be treated S and the coolant. Therefore, in the present embodiment, the immersion step in which the relative flow velocity is generated is completed during the vapor film stage in which the cooling rate is low. As a result, the influence of the relative flow velocity in the immersion step can be reduced, that is, the difference in the cooling rate of the object to be treated S upstream and downstream of the relative flow velocity can be minimized.

When it is determined in step S120 that the depth of the lower end of the object to be treated S has reached the stroke ST, the motor M stops lowering of the support base 21 (step S125). That is, the control device outputs a predetermined control signal to the motor M to stop the operation of the motor M and stop lowering of the support base 21. In the present embodiment, the coolant W does not flow in the cooling tank 10. In the present embodiment, the cooling tank 10 is not provided with a mechanism for moving the coolant W by applying an external force to the coolant W by a propeller, a pump, or the like. Therefore, when lowering of the support base 21 is stopped, a relative flow velocity is not applied between the object to be treated S and the coolant W around the object to be treated S.

Therefore, when lowering of the support base 21 is stopped, there is no factor that causes the coolant W to flow around the object to be treated S except for natural convection, and the periphery of the object to be treated S is extremely stable. Therefore, according to the present embodiment, there is no factor that promotes the cooling of the object to be treated S, and the cooling rate of the object to be treated S does not differ for each portion. As a result, the object to be treated S is not unevenly cooled, and the possibility that the degree of progress of quenching is uneven can be reduced.

In step S125, when the vapor film maintaining period T elapses in a state where the lowering of the support base 21 is stopped, the vapor film disappears. When the vapor film disappears from the periphery of the object to be treated S and the object to be treated S comes into contact with the liquid coolant W, rapid cooling is started. When the rapid cooling is started, the temperature of the object to be treated S reaches a martensite transformation start temperature Ms, and the martensite transformation progresses from the surface of the object to be treated S.

In the present embodiment, a predetermined period in which the martensite fraction of the surface of the object to be treated S is a predetermined value is identified in advance. The predetermined period can be defined by, for example, an elapsed time length from the start of immersion.

A martensite fraction P is expressed by

$$P ( t ) = 1 - exp ( - b ( Ms - t ) )$$

where t is a temperature
Ms is a martensite transformation start temperature, and
b is a constant (for example, in the SCM420, b=0.143 in the base material, and b=0.01 in the case of carburization at a face carbon concentration of 0.8 (mass %)) identified by a material and a carbon concentration.

In the present embodiment, when the martensite fraction of the surface of the object to be treated S reaches a predetermined value, it is regarded that the surface of the object to be treated S has undergone martensite transformation. Since the object to be treated S is harder and less likely to be distorted as the martensite fraction increases, it can be said that the condition that the martensite fraction is a predetermined value is a condition for suppressing the magnitude of distortion to an allowable magnitude or less. For example, various values such as 21%, 28%, 50%, and 61% may be defined as predetermined values according to the magnitude of the allowable distortion. A predetermined period, which is a period until the martensite fraction reaches the predetermined value, can be identified in advance by an experiment or a simulation. In the present embodiment, it is determined in step S130 whether the predetermined period has elapsed, and when the predetermined period has elapsed, it is regarded that the surface of the object to be treated S has undergone martensite transformation and quenching has been sufficiently performed. Whether the predetermined period has elapsed can be determined by measuring an elapsed time from the start of immersion by a timing device (not illustrated).

The cooling tank 10 according to the present embodiment is not provided with a mechanism for moving the coolant W by applying an external force by a propeller, a pump, or the like. Therefore, the coolant W does not flow by the external force even in a period until it is determined in step S130 that the predetermined period has elapsed after the support base 21 is stopped. That is, in a period until the surface of the object to be treated S undergoes martensite transformation, a state in which the coolant W is not moved by an external force is maintained. Therefore, there is little possibility that the cooling rate of the surface of the object to be treated S is uneven due to the flow of the coolant W. When a mechanism for moving the coolant W is provided in the cooling tank 10, the coolant W may be moved to promote cooling after it is determined in step S130 that the predetermined period has elapsed.

In step S135, it is determined whether the object to be treated S has reached a predetermined temperature. That is, a temperature at which the object to be treated S is taken out from the coolant Wis determined in advance as a predetermined temperature. The determination as to whether the predetermined temperature has been reached can be realized by various configurations, and may be performed based on, for example, detection results by various sensors, measurement of a time length, and the like.

When it is determined in step S135 that the object to be treated S has reached the predetermined temperature, the object to be treated is raised (step S140). That is, the moving device 20 is controlled, and the support base 21 is raised. As a result, the state in which the object to be treated S is immersed in the coolant W ends, and the heat treatment step ends. Of course, this cooling step is an example, and after this, heat treatment such as tempering, annealing, and high frequency heating may be performed.

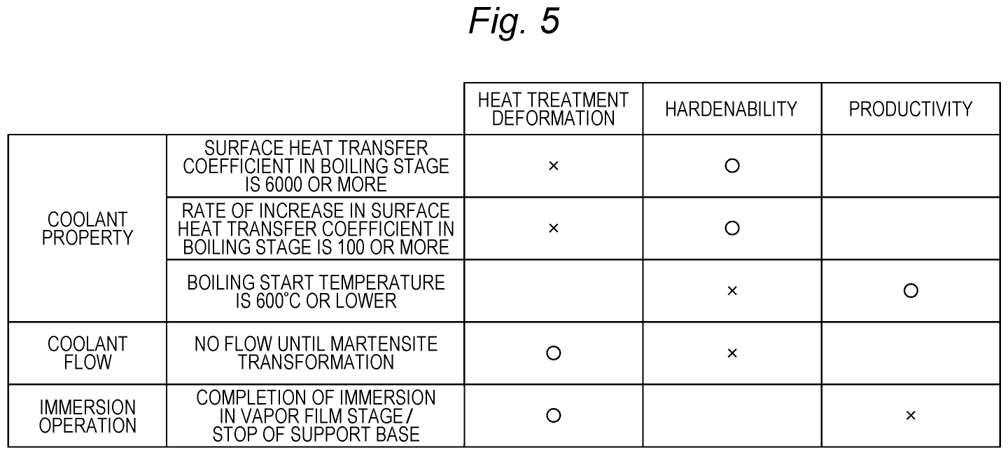

Here, effects obtained by bringing the coolant W into a non-flowing state as illustrated in FIG. 4, completing the immersion within the vapor film maintaining period T, and stopping the support base 21 will be described. FIG. 5 is a diagram illustrating effects of each of the technical ideas used in the present embodiment. In FIG. 5, the technical ideas are illustrated for respective elements on the left side.

Specifically, when the coolant W having a surface heat transfer coefficient of 6000 W/m²·K or more in the boiling stage is used, a large amount of heat can be transferred from the object to be treated S to the coolant W after the transition to the boiling stage, the cooling rate of the inside of the object to be treated S increases, and the hardenability of the inside of the object to be treated S is improved. In FIG. 5, the fact that the hardenability is improved by using the coolant W having a surface heat transfer coefficient of 6000 W/m²·K or more is indicated by the circle in a column of hardenability.

On the other hand, the coolant W having a surface heat transfer coefficient of 6000 W/m²·K or more in the boiling stage has a very high cooling capacity, so that the object to be treated S is likely to be distorted. That is, in a state where the coolant W around the object to be treated S flows in one direction, the relative flow velocity between the object to be treated S and the coolant W is large upstream of the flow of the coolant W, and the coolant W is easily stirred. In addition, the coolant W easily accumulates downstream of the flow of the coolant W, and the relative flow velocity is small. Therefore, the portion upstream of the flow has a higher cooling rate than the portion downstream, and the difference in cooling rate is significant for each portion of the object to be treated S. As a result, distortion occurs in the object to be treated S after quenching. In FIG. 5, the fact that distortion is likely to occur as the coolant W having high cooling capacity is used is indicated by x in a column of heat treatment deformation.

Therefore, in order to prevent the coolant W from stirring and accumulating due to the flow of the coolant, after the object to be treated S is immersed in the W accumulated in a state of the coolant not flowing in the cooling tank 10 and the support base 21 is stopped, a state in which a relative flow velocity is not applied between the object to be treated S and the coolant W is maintained until the surface of the object to be treated S undergoes martensite transformation. Therefore, in the present embodiment, a situation in which cooling is promoted in a portion of the object to be treated S and cooling is suppressed in the other portion after the transition to the boiling stage does not occur. Therefore, a difference in cooling rate is less likely to occur for each portion of the object to be treated S, and as a result, a difference in deformation amount is less likely to occur for each portion of the object to be treated S. By maintaining a state in which a relative flow velocity is not applied between the object to be treated S and the coolant W at least until the surface of the object to be treated S undergoes martensite transformation, it is possible to reduce the difference in expansion accompanying the martensite transformation upstream and downstream of the object to be treated S, which occurs when the relative flow velocity is applied, and to reduce the distortion of the object to be treated S after quenching. Further, in the present embodiment, the immersion operation is performed so as to complete the immersion and stop the support base during the vapor film stage of the coolant W. When the object to be treated S is immersed in the non-flowing coolant W, a relative flow velocity is generated between the object to be treated S and the coolant W. However, in the present embodiment, the immersion step is completed during the vapor film stage in which the cooling rate is low. Therefore, the influence of the relative flow velocity generated around the object to be treated S in the immersion step is small, that is, the difference in the cooling rate of the object to be treated S upstream and downstream of the relative flow velocity can be reduced as much as possible. As a result, a difference hardly occurs in the deformation amount of each portion of the object to be treated S. In FIG. 5, a circle in a column of heat treatment deformation indicates that a difference hardly occurs in the deformation amount for each portion.

When the coolant Wis not caused to flow until the surface of the object to be treated S undergoes martensite transformation in the state of shifting to the boiling stage, the cooling rate inside the object to be treated S is reduced as compared with the case where the coolant W around the object to be treated S flow, so that the desired internal hardness and cured layer depth of the object to be treated S may not be obtained in some cases, leading to deterioration of hardenability inside the object to be treated S. In FIG. 5, the decrease in hardenability as the coolant W is not caused to flow until the surface of the object to be treated undergoes martensite transformation is indicated by x in a column of hardenability.

A decrease in hardenability can be prevented by increasing an alloy (Cr, Mo, Mn, Ni, B, Si, V) that improves hardenability as a material of the object to be treated S, but Mo, Ni, V, and the like are expensive, leading to an increase in cost. Therefore, the decrease in hardenability can be rephrased as an increase in material cost. However, in the present embodiment, since the coolant W having a high hardenability and having a surface heat transfer coefficient of 6000 W/m²·K or more in the boiling stage is used, the hardenability associated with no flow of the coolant W is not deteriorated.

In addition, when the coolant W having a rate of increase in a surface heat transfer coefficient of 100 W/m²·K² or more in the boiling stage is used, rapid cooling can be performed at a sufficient speed in the boiling stage, and as in the case of using the coolant W having a surface heat transfer coefficient of 6000 W/m²·K or more in the boiling stage, the cooling rate of the inside of the object to be treated S increases, and hardenability of the inside of the object to be treated S is improved. In FIG. 5, the fact that the hardenability is improved by using the coolant W having a rate of increase in a surface heat transfer coefficient at the boiling stage of 100 W/m²·K² or more is indicated by a circle in a column of hardenability.

The coolant W having the rate of increase in the surface heat transfer coefficient at the boiling stage of 100 W/m²·K² or more has a high cooling capacity. Therefore, when there is a difference in the degree of cooling for each portion of the object to be treated S, distortion is likely to occur as in the coolant W having the surface heat transfer coefficient at the boiling stage of 6000 W/m²·K or more. In FIG. 5, the fact that distortion is likely to occur as the coolant W having high cooling capacity is used is indicated by x in a column of heat treatment deformation. However, in the present embodiment, a state in which a relative flow velocity is not applied between the object to be treated S and the coolant W is maintained until the surface of the object to be treated S undergoes martensite transformation, and further, the immersion operation is performed so as to complete the immersion and stop the support base during the vapor film stage of the coolant W, so that heat treatment deformation is less likely to occur as described above.

In addition, in order to complete the immersion during the vapor film stage, the upper face of the object to be treated S is required to reach the liquid level or less within the vapor film maintaining period T, and the support base 21 is required to be lowered at a high speed. As the moving speed of the support base 21 increases, the configuration of the facility for driving the support base 21 is large, and the facility having durability for withstanding repeated quenching in the production process is required. For example, the device for lowering the support base 21 inevitably has restrictions such as an upper limit loading load and a lowering speed upper limit value, and an excessive cost is required to increase these upper limits. When the lowering speed of the support base 21 has an upper limit, it is necessary to limit the height of the object to be treated S so that immersion can be completed at the lowering speed or less. For this reason, there is a restriction on the number of objects to be treated S to be disposed when the plurality of objects to be treated S is disposed in the vertical direction and placed on the support base 21. In FIG. 5, the fact that it is difficult to design the facility and the number of objects to be treated S disposed in the height direction is restricted as the support base 21 is lowered at a high speed is indicated by x in a column of productivity.

As described above, when the immersion is completed during the vapor film stage, it is difficult to improve the productivity. However, in the present embodiment, the use of the coolant W having a boiling start temperature of 600° C. or lower does not to reduce the productivity. That is, when the coolant W having a boiling start temperature of 600° C. or lower is used, for example, when immersion is started in a state where the surface temperature of the object to be treated S is about 800° C., the vapor film is maintained until the object to be treated S is cooled by about 175° C. As described above, when the boiling start temperature is 600° C. or lower, a time margin for completing immersion during the vapor film stage can be secured. Therefore, the immersion of the object to be treated S can be completed during the vapor film maintaining period T without moving the object to be treated S at an excessively high speed. In FIG. 5, the fact that the use of the coolant W having a boiling start temperature of 600° C. or lower can secure a time margin for completing immersion during the vapor film stage is indicated by a circle in a column of productivity.

As described above, when the coolant W having the boiling start temperature of 600° C. or lower is used, the vapor film maintaining period T having a sufficient length can be obtained, but when the vapor film maintaining period T is long, it takes time from the start of immersion of the object to be treated S to the start of rapid cooling. That is, when the transition temperature to the boiling stage is low, the magnitude of the cooling rate inside the object to be treated S is insufficient, leading to a quenching failure (deterioration in internal hardness and cured layer depth). In FIG. 5, the decrease in hardenability with the use of the coolant W having a boiling start temperature of 600° C. or lower is indicated by x in a column of hardenability.

As described above, when the coolant W having a boiling start temperature of 600° C. or lower is used, it is difficult to increase the cooling rate. However, in the present embodiment, by using the coolant W having a surface heat transfer coefficient of 6000 W/m²·K or more in the boiling stage or using the coolant W having a rate of increase in a surface heat transfer coefficient of 100 W/m²·K² or more in the boiling stage, the cooling rate inside the object to be treated S is increased. Therefore, the hardenability is not deteriorated as described above.

As described above, the disadvantages of using each of the technical ideas in the present embodiment are compensated by the advantages of other technical ideas. Therefore, according to the present embodiment, it is possible to provide a quenching method in which a difference in cooling rate in the vertical direction is reduced and distortion hardly occurs without requiring a deep cooling tank.

### (3) Examples

Next, a state of quenching in the above-described heat treatment step will be described. Here, an example in which a cylindrical shaft (Diameter: 36 mm, axial length: 148 mm) formed using the SCM420 is the object to be treated S, the object to be treated S is supported on the support base 21 so as not to roll in a state where the axial direction of the shaft is oriented in the horizontal direction, and quenching is performed will be described. A sample obtained by performing quenching on the object to be treated S in the heat treatment step illustrated in FIG. 3 is referred to as Example 1, and a sample obtained by performing quenching in the heat treatment step illustrated in FIG. 3 in a state where the coolant W in the cooling tank 10 is caused to flow is referred to as Comparative Example 1.

In the heat treatment step of Comparative Example 1, the coolant W in the cooling tank 10 flows in a certain direction around the object to be treated S. Such a configuration can be realized, for example, by providing a flow unit such as a propeller that causes the coolant W to flow by an external force inside the cooling tank 10, and by configuring so that the coolant W circulating inside the cooling tank 10 flows in a certain direction around the object to be treated S by the flow unit. That is, in Comparative Example 1, quenching is performed in a state where the coolant W flows in the same direction parallel to the descending direction of the support base 21 around the object to be treated S. Here, the magnitude of the flow velocity Vq of the coolant W is set to be the same as the magnitude of the lowering speed Ve. Therefore, while the support base 21 is descending, the relative speed between the object to be treated S and the coolant W is 0, but when the support base 21 is stopped, the coolant W has a relative speed Ve (=Vq) in the downward direction with respect to the object to be treated S.

In both Example 1 and Comparative Example 1, the stroke ST is 520 mm. In both Example 1 and Comparative Example 1, the coolant W is a 20% water-soluble coolant. The internal temperature of the object to be treated S at the start of immersion in the coolant W is 850° C. The object to be treated S has been carburized with a surface layer of 1 mm at a face carbon concentration of 0.8 (mass %). The lowering speed Ve is 400 mm/s in both Example 1 and Comparative Example 1, but the flow velocity Vq of the coolant W is 0 mm/s in Example 1 and 400 mm/s in the downward direction in Comparative Example 1. In both Example 1 and Comparative Example 1, the temperature of the coolant Wis room temperature (for example, 25° C.).

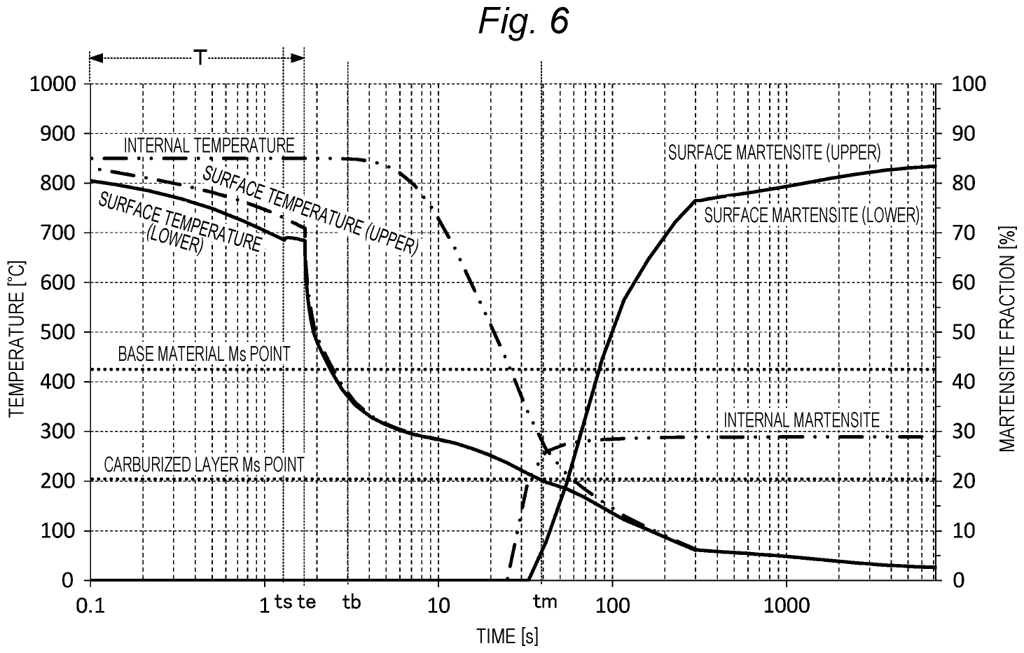

FIG. 6 is a diagram illustrating a temperature change and a martensite fraction of the object to be treated S as Example 1. The horizontal axis represents time in logarithm, the left vertical axis represents temperature, and the right vertical axis represents martensite fraction. In FIG. 6, the graph illustrates transition of the temperature and the martensite fraction of the object to be treated S for each elapsed time after the object to be treated S comes into contact with the coolant W. In FIG. 6, the temperature and the martensite fraction of the surface of the central portion of the lowermost portion of the object to be treated S in the axial direction are indicated by solid lines. In addition, the temperature and the martensite fraction of the surface of the central portion of the uppermost portion of the object to be treated S in the axial direction are indicated by one-dot chain lines. In the Example, since the martensite fraction of the uppermost portion surface of the object to be treated S and the martensite fraction of the lowermost portion surface overlap each other, only the solid line is visible. Furthermore, the temperature and the martensite fraction of the inside (the center of) of the object to be treated S are indicated by two-dot chain lines.

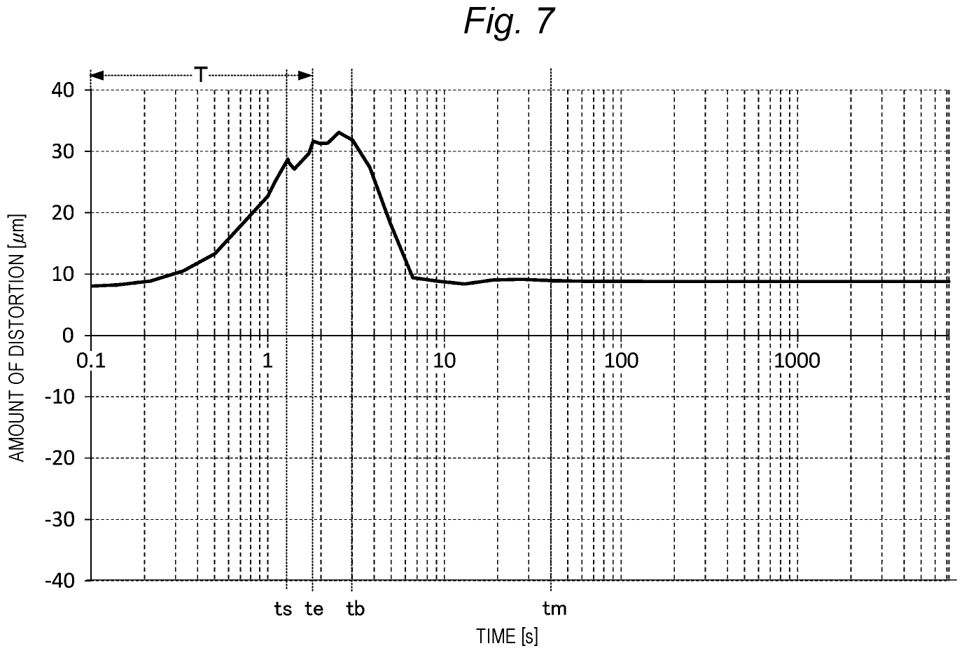

FIG. 7 illustrates a temporal change in the amount of distortion in Example 1. In FIG. 7, the horizontal axis represents time in logarithm, and the vertical axis represents the amount of distortion. The amount of distortion (bending amount) indicates how much the cylindrical axis of the object to be treated S is bent in the vertical direction, and indicates the distance between the uppermost portion and the lowermost portion of the cylindrical axis of the object to be treated S in the vertical direction. In addition, which of the center and the end of the cylindrical shaft is located above is indicated by positive and negative. A positive value indicates a bending manner (convex upward) in which the center of the cylindrical axis is above the end portion, and a negative value indicates a bending manner (convex downward) in which the center of the cylindrical axis is below the end portion.

When the immersion of the object to be treated S is started, the difference in immersion start timing between the upper part and the lower part of the object to be treated S is reflected, and as illustrated in FIG. 6, a difference in temperature is generated between the surface of the lowermost portion and the surface of the uppermost portion of the object to be treated S. In this state, as time elapses, the object to be treated S gradually cools with a difference in temperature between the surface of the lowermost portion and the surface of the uppermost portion of the object to be treated S.

In Example 1, since the immersion is completed and the support base 21 is stopped while the object to be treated S is covered with the vapor film, the difference in temperature generated between the surface of the lowermost portion and the surface of the uppermost portion of the object to be treated S does not increase. Specifically, when the object to be treated S is immersed in the coolant W according to the present embodiment, a vapor film is formed around the immersed portion. Therefore, heat exchange between the object to be treated S and the coolant W is performed via the vapor film from the start of immersion to time the at which the vapor film maintaining period T elapses. Therefore, the cooling rate after the start of immersion is relatively slow, and is about 100° C./sec. According to FIG. 6, in Example 1, it can be seen that the difference in temperature between the surface of the lowermost portion and the surface of the uppermost portion of the object to be treated S remains substantially constant from the start of immersion to time ts.

In the object to be treated S, distortion reflecting a difference in temperature occurs. When the lower part of the object to be treated S is colder than the upper part as in the present Example 1, the degree of thermal expansion of the upper part of the object to be treated S is larger than that of the lower part, so that the upper part of the object to be treated S is longer and the lower part is shorter in the axial direction. As a result, the amount of distortion of the object to be treated S is positive (convex upward). In the present Example 1, as illustrated in FIG. 7, positive distortion occurs immediately after the start of immersion, and the amount of distortion gradually increases.

After the start of the immersion, the support base 21 stops within the vapor film maintaining period T in which the vapor film is maintained. In FIG. 6, the support base 21 stops at time ts (time when 1.3 seconds have elapsed from the start of immersion). In the present embodiment, the cooling tank 10 does not include a mechanism for causing the coolant W to flow, and the coolant W does not flow. Therefore, after the support base 21 stops at time ts, the position of the coolant W around the object to be treated S hardly changes.

For this reason, a relative flow velocity is not generated between the object to be treated S and the coolant W around the object to be treated S, and there is a low possibility that a difference in cooling rate is generated at the upper part and the lower part of the object to be treated due to a difference in relative flow velocity between the object to be treated S and the coolant W. As a result, as illustrated in FIG. 7, the distortion increases substantially uniformly from the start of immersion to time te after time ts.

In the present embodiment, the vapor film disappears at time te after time ts. In the shaft according to the present embodiment, the axial end of the lowermost portion of the object to be treated S is cooled earliest, and when the temperature of the end reaches 545° C. which is the temperature in FIG. 4 (the surface temperature of the object to be treated S is 570° C.), the shaft shifts to the boiling stage. In the shaft according to the present embodiment, when the periphery of a portion of the object to be treated S shifts to the boiling stage, the vapor film around the shaft peels off with the shift as a trigger, and the shaft shifts to the boiling stage. Therefore, in the example illustrated in FIG. 6, the vapor film is peeled off at the stage where the surface temperature of the uppermost portion of the object to be treated S is 710° C. and the surface temperature of the lowermost portion is 680° C.

When the vapor film disappears, the liquid coolant W comes into contact with the surface of the object to be treated S. Since the surface heat transfer coefficient of the liquid coolant W is larger than the surface heat transfer coefficient of the coolant W of the vapor film, cooling rapidly proceeds after time te. After time te, for a while, as illustrated in FIG. 6, a difference in temperature between the lowermost portion and the uppermost portion of the object to be treated S can be observed. However, after the object to be treated S is rapidly cooled, as illustrated in FIG. 6, the cooling rate decreases near time tb, so that the difference in temperature occurring between the lowermost portion and the uppermost portion gradually disappears. Therefore, the degree of thermal expansion at the uppermost portion of the object to be treated S approaches the degree of thermal expansion at the lowermost portion from around time tb, and as illustrated in FIG. 7, the amount of distortion gradually decreases after time tb.

The difference in temperature between the lowermost portion and the uppermost portion of the object to be treated S is substantially eliminated before time tm at which the temperature of the surface of the object to be treated S reaches the martensite transformation start temperature (denoted as a carburized layer Ms point in FIG. 6) at the surface, and the amount of distortion converges to a minimum value (about 9 μm) after time tb. As described above, in Example 1 illustrated in FIGS. 6 and 7, the lowering of the object to be treated S is stopped while the vapor film is formed around the object to be treated S, and the state in which the coolant W does not flow is maintained. Therefore, even in the period in which the vapor film is formed, and even after the vapor film disappears and rapid cooling is started, the coolant W around the object to be treated S does not flow and the relative flow velocity between the object to be treated S and the coolant W does not occur. Therefore, there is a low possibility that the difference in cooling rate due to the difference in relative flow velocity is caused between the portions of the object to be treated S. Therefore, cooling does not partially proceed in the object to be treated S, and a difference in temperature in the object to be treated S hardly occurs. Therefore, distortion is less likely to occur in the object to be treated S.

When the surface of the object to be treated S is equal to or lower than the martensite transformation start temperature, martensite is formed on the surface of the object to be treated S. As illustrated in FIG. 6, there is no difference in the temporal change in the martensite fraction of the surface between the lowermost portion and the uppermost portion of the object to be treated S. Therefore, the amount of distortion remaining on the object to be treated S after quenching is very small.

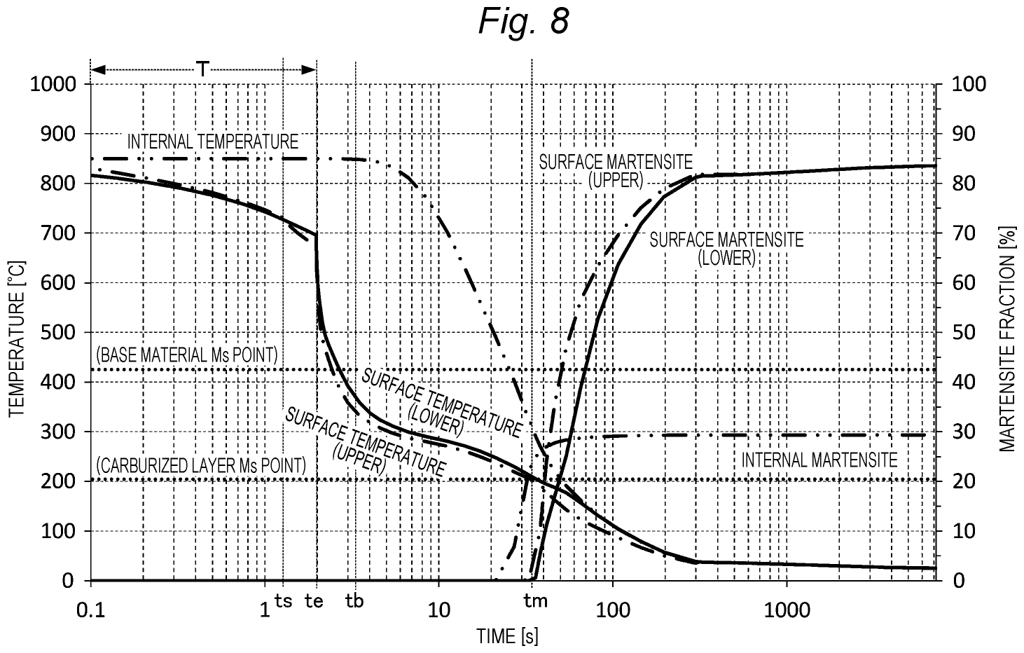

FIG. 8 is a diagram illustrating a temperature change and a martensite fraction of the object to be treated S as Comparative Example 1. The horizontal axis represents time in logarithm, the left vertical axis represents temperature, and the right vertical axis represents martensite fraction. In FIG. 8, the graph illustrates transition of the temperature and the martensite fraction of the object to be treated S for each elapsed time after the object to be treated S comes into contact with the coolant W. In FIG. 8, the temperature of the surface and the martensite fraction of the lowermost portion of the object to be treated S are indicated by solid lines. In addition, the temperature of the surface and the martensite fraction of the uppermost portion of the object to be treated S are indicated by one-dot chain lines, and the temperature and the martensite fraction of the inside (center) of the object to be treated S are indicated by two-dot chain lines.

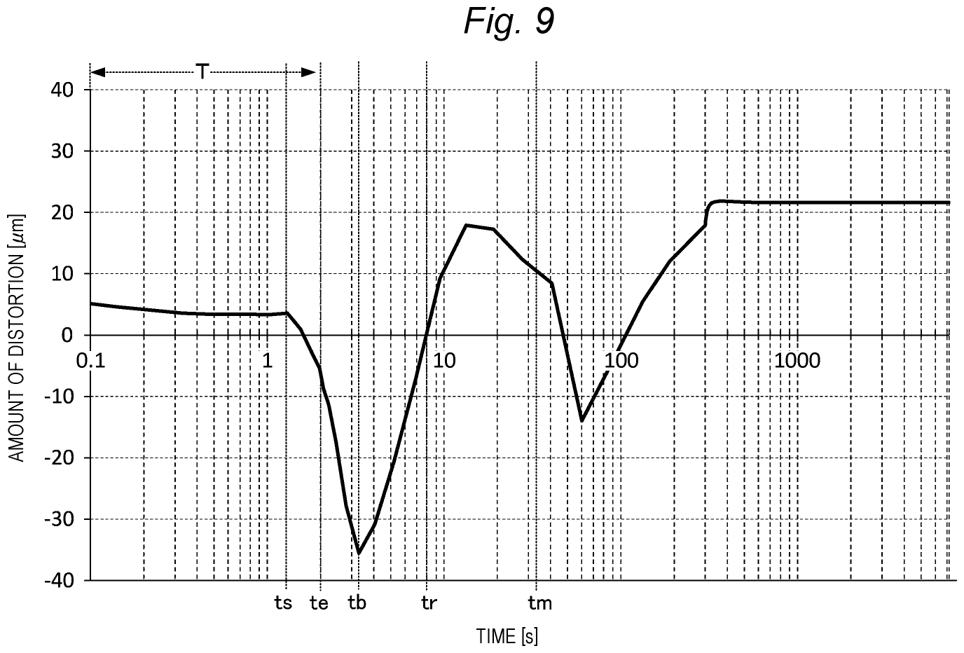

FIG. 9 illustrates a temporal change in the amount of distortion in Comparative Example 1. In FIG. 9, the horizontal axis represents time in logarithm, and the vertical axis represents the amount of distortion. The definition of the amount of distortion is the same as the definition in Example 1 illustrated in FIG. 7.

When the immersion of the object to be treated S is started, the difference in immersion start timing between the upper part and the lower part of the object to be treated S is reflected, and as illustrated in FIG. 8, a slight difference in temperature is generated between the surface of the lowermost portion and the surface of the uppermost portion of the object to be treated S. However, in Comparative Example 1, since the coolant W flows downward at the same speed as the lowering speed of the object to be treated S, the difference in temperature is smaller than that in Example 1. Specifically, the lowering speed Ve when the support base 21 moves the object to be treated S downward and the flow velocity Vq of the coolant W are the same in magnitude and direction. Therefore, the coolant W moves downward together with the object to be treated S, and a relative flow velocity is less likely to occur between the object to be treated S and the coolant W.

As illustrated in FIG. 8, in Comparative Example 1, the object to be treated is cooled in a state where the temperature of the lowermost portion and the temperature of the uppermost portion of the object to be treated are close to each other in the vapor film maintaining period T. Also in Comparative Example 1, heat exchange between the object to be treated S and the coolant W in the vapor film maintaining period T is performed via the vapor film. Therefore, the cooling rate after the start of immersion is relatively slow, and is about 100° C./sec.

Since the distortion reflecting the difference in temperature occurs in the object to be treated S, in Comparative Example 1 as well, that the lower part of the object to be treated S is colder than the upper part is reflected, and the amount of distortion is positive (convex upward) immediately after the start of immersion. In Comparative Example 1, since the difference in temperature between the upper part and the lower part of the object to be treated S immediately after the start of immersion is smaller than that in Example 1, the amount of distortion immediately after the start of immersion is smaller than that in Example. In Comparative Example 1, since the difference in temperature between the upper part and the lower part of the object to be treated S is substantially constant, the amount of distortion does not change much until time ts.

Also in Comparative Example 1, the support base 21 stops during the vapor film maintaining period T in which the vapor film is maintained. In FIG. 8, the support base 21 stops at time ts (time when 1.3 seconds have elapsed from the start of immersion). However, in Comparative Example 1, the coolant W moves downward at the lowering speed Vq around the object to be treated S. Therefore, in a state where the support base 21 is stopped at time ts, the coolant W around the object to be treated S flows downward. Therefore, in the axially central portion of the object to be treated S, the coolant W is stirred upstream of the flow of the coolant W (the upper part of the object to be treated S), the relative flow velocity between the object to be treated S and the coolant W is large, and the coolant W accumulates downstream (the lower part of the object to be treated S), and the relative flow velocity is small.

Under such circumstances, cooling is promoted around the upper part of the object to be treated S, and cooling is suppressed around the lower part of the object to be treated S.

As described above, in Comparative Example 1, after the support base 21 stops at time ts, the upper part of the object to be treated S is more easily cooled than the lower part. Referring to FIG. 8, it can be seen that the surface temperature of the upper part of the object to be treated S decreases earlier than the surface temperature of the lower part. In this case, with the lapse of time, the degree of thermal expansion in the lower part of the object to be treated S is larger than that in the upper part, and as illustrated in FIG. 9, the amount of distortion changes from positive to negative after time ts.

Also in Comparative Example 1, the vapor film disappears at time te, but in the rapid cooling stage immediately after the vapor film disappears, the surface temperature of the upper part is lower than the surface temperature of the lower part, and the cooling is promoted at the upper part relative to at the lower part. Therefore, after time te, the negative amount of distortion rapidly increases.

After the object to be treated S is rapidly cooled, as illustrated in FIG. 8, the cooling rate decreases near time tb, so that the difference in temperature occurring between the upper part and the lower part is eliminated also in Comparative Example 1. Therefore, as illustrated in FIG. 9, the absolute value of the amount of distortion decreases after time tb. However, in Comparative Example 1, since the cooling of the upper part is promoted by the flow of the coolant W, it is difficult to eliminate the difference in temperature between the upper part and the lower part even when the cooling rate decreases near time tb. In the present Comparative Example, as illustrated in FIG. 8, there is a difference in temperature between the lowermost portion and the uppermost portion of the object to be treated S even at time tm when the martensite transformation start temperature (carburized layer Ms point) at the surface of the object to be treated S is reached.

As described above, in the present Comparative Example, there is a difference in temperature between the lowermost portion and the uppermost portion of the object to be treated S at the stage of reaching the martensite transformation start temperature, and the upper part of the object to be treated S is consistently lower than the lower part at time te to time tm. Therefore, when considered from the temperature of the surface of the object to be treated S, it seems that the lower part of the object to be treated S has a larger degree of thermal expansion than the upper part and the object is convex downward. However, in the Comparative Example, as illustrated in FIG. 9, the amount of distortion of the object to be treated S is a positive value at time tr and the object is convex upward.

This is considered because the portion of the very surface layer of the object to be treated S reaches the martensite transformation start temperature early as compared with the portion slightly deeper than the surface layer, and volume expansion occurs due to martensite transformation. That is, in FIG. 8, a portion slightly deeper than the surface layer is regarded as the surface of the object to be treated S, and a portion slightly deeper than the surface layer is expressed as “surface martensite” to indicate the martensite fraction, but the martensite transformation can be started earlier at the actual surface layer of the object to be treated S.

As described above, when there is a difference in temperature at the surface or surface layer of the object to be treated S, the timing at which the martensite transformation starts differs for each portion of the object to be treated S. As a result, as illustrated in FIG. 9, the amount of distortion of the object to be treated S is a value different from the value expected only from the surface of the object to be treated S, and changes very complicatedly with time.

Further, in the upper part of the object to be treated S, the surface which is a portion slightly deeper than the surface layer reaches the martensite transformation start temperature at time tm, and the martensite fraction increases after time tm. At time tm, there is a difference in temperature between the surface of the upper part and the surface of the lower part of the object to be treated S, and the lower part reaches the martensite transformation start temperature later, so that the martensite fraction of the lower part increases later than the upper part.

Therefore, the temporal change in the volume expansion accompanying the martensite transformation is different between the upper part and the lower part of the object to be treated S, and such a difference in the degree of volume expansion for each part of the object to be treated S causes distortion. In Comparative Example 1 illustrated in FIG. 9, as a result of a change in the amount of distortion due to various factors, the amount of distortion is 22 μm after completion of quenching. As described above, in Comparative Example 1, since the amount of distortion changes complicatedly, the amount of distortion is larger than that in Example in which the coolant W does not flow after the support base 21 is stopped.

As described above with reference to FIG. 6, in Example 1, the lowering of the support base 21 is stopped within the vapor film maintaining period T, and a state in which the relative flow velocity is not applied between the object to be treated S and the coolant W is maintained at least until the surface of the object to be treated S undergoes martensite transformation. Therefore, even when a slight difference in temperature occurs in each portion of the object to be treated S at the stage when the vapor film disappears, the difference in temperature is eliminated or substantially eliminated at the stage when the martensite transformation start temperature is reached. Therefore, a difference is less likely to occur in the martensite formation rate for each portion of the object to be treated S, and distortion is less likely to occur.

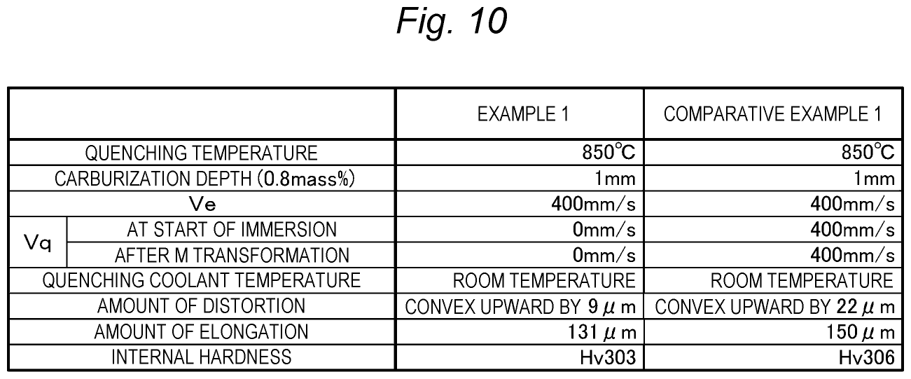

FIG. 10 illustrates the amount of distortion (bending amount) (μm), the amount of elongation (μm), and the internal hardness (Hv) of the object to be treated S of Example 1 and Comparative Example 1 as described above. The amount of distortion (bending amount) is defined as in FIGS. 7 and 9 described above. The amount of elongation is a difference between the axial length of the object to be treated S after completion of quenching and the axial length of the object to be treated S not subjected to heat treatment at room temperature. The internal hardness is the Vickers hardness at the center of the object to be treated S.

In the above example, when Example 1 and Comparative Example 1 are compared, the internal hardness is equivalent, but the amounts of distortions are respectively convex upward by 9 μm and convex upward by 22 μm, and the amounts of elongations are respectively 131 μm and 150 μm. Therefore, the amount of distortion and the amount of elongation are smaller in Example 1. As described above, during quenching in Example 1, the coolant W is not flowed by an external force. Therefore, the amount of distortion and the amount of elongation in Example 1 are smaller than those in Comparative Example 1 in which the coolant W flows and the cooling rate is uneven for each portion of the object to be treated S.

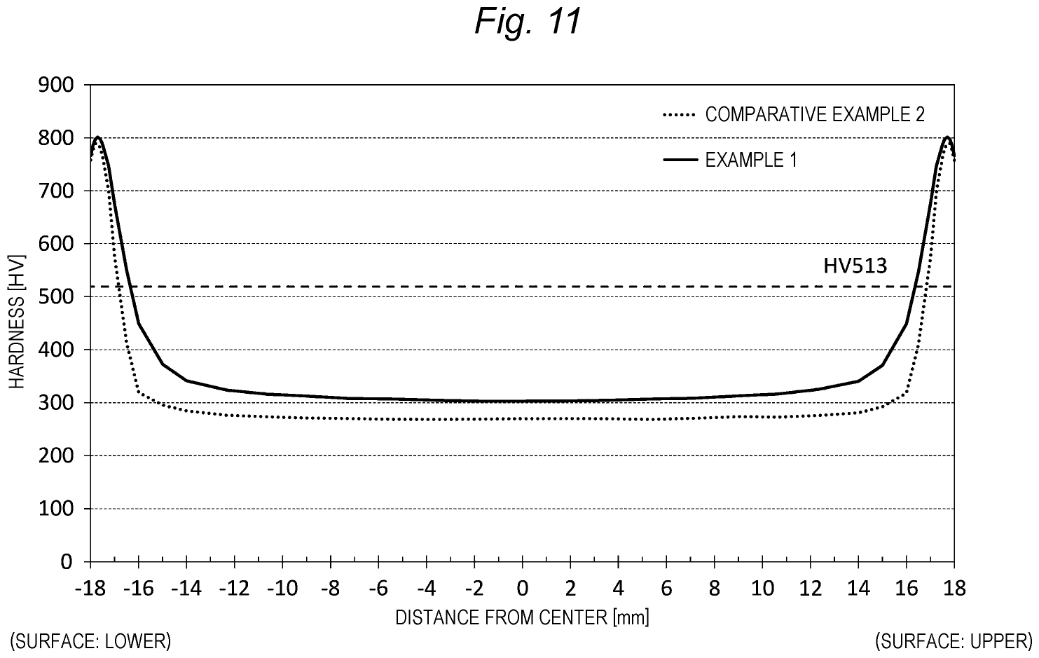

As illustrated in FIG. 4, in the case of a liquid in which there is a temperature zone in which the amount of change in surface heat transfer coefficient with respect to the amount of decrease in temperature after immersion is equal to or less than the predetermined value, there is the vapor film maintaining period T. Therefore, immersion is completed within the vapor film maintaining period T, and lowering is stopped, so that quenching with less heat treatment deformation and high surface hardness can be performed. However, when the coolant W in which the maximum value of the surface heat transfer coefficient in the boiling stage is 6000 W/m²·K or more is used, the internal hardness and the depth of the cured layer can be improved and the effective curing depth can be increased in the object to be treated S of the same material as compared with the case where hot oil is used. FIG. 11 is a diagram illustrating hardness in Example 1 in which quenching was performed with a 20% water-soluble coolant at a lowering speed Ve of 400 mm/s as described above, and Comparative Example 2 in which quenching was performed with a relative speed between the object to be treated S and the coolant W around the object to be treated S set to 400 mm/s after immersion and stop with hot oil at the lowering speed Ve of 400 mm/s. In the graph illustrated in FIG. 11, the horizontal axis represents the distance from the center, and the vertical axis represents the Vickers hardness. The center is the cylindrical axis of the object to be treated S, and the distance from the cylindrical axis toward the lowermost portion is indicated by a negative value, and the distance from the cylindrical axis toward the uppermost portion is indicated by a positive value. In FIG. 11, the Vickers hardness of Example 1 is indicated by a solid line, and the Vickers hardness of Comparative Example 2 is indicated by a broken line. In addition, a broken line indicating 513HV of the Vickers hardness as an index for evaluating the effective curing depth is indicated.

As illustrated in this figure, the Vickers hardness of Comparative Example 2 is smaller than that of Example 1 over the entire region from the surface to the inside of the object to be treated S. Therefore, it can be said that the effective curing depth of Comparative Example 2 is shallower than that of Example 1. As described above, when the object to be treated S of the same material is quenched, the use of the water-soluble coolant as the coolant W makes it possible to obtain the object to be treated S having a deeper effective curing depth than the use of hot oil.

### (4) Other Embodiments

The above embodiment is an example for carrying out the present disclosure, and various other embodiments can be used. For example, the object to be treated S is not limited to the shaft, and various articles such as a gear and a building component may be the object to be treated. Various postures may be used as the posture of the object to be treated S at the time of quenching. Any configuration can be used as long as the object to be treated S is fixed to a portion, such as the support base 21, for lowering the object to be treated S, and the object to be treated S stands still in the coolant W that has not flowed as the support base 21 descends. Furthermore, in order to stabilize the generation of the vapor film, the air pressure in the atmosphere of the cooling tank 10 may be adjusted. Specifically, the vapor film is stabilized as the air pressure in the atmosphere of the cooling tank 10 increases, and the vapor film is unstable as the air pressure decreases. Therefore, the pressure may be increased so that the air pressure is a predetermined value or more until the lowering of the object to be treated is completed, and the pressure may be reduced so that the air pressure is smaller than the predetermined value after the lowering of the object to be treated is stopped.

The quenching may be a heat treatment in which the metal is rapidly cooled after being heated to a predetermined temperature, and various materials may be assumed as the object to be treated. For example, the quenching is not limited to the quenching in which the carburized steel is quenched as in the above-described embodiment, but may be the quenching in which steel containing carbon is prepared in advance and quenched after the steel is heated. The object to be treated may be a material subjected to carburization or nitriding or a material subjected to nitrocarburization.

The material of the object to be treated is not limited as long as the object to be treated is an object to be quenched. For example, various steel materials, general rolled steel materials, carbon steel materials, alloy steel, carburizing steel, tool steel, spring steel, bearing steel, hot-rolled steel sheet, cold-rolled steel sheet, and carbon steel cast steel may be the object to be treated. Further, steel materials defined in material standards such as JIS, SAE, and DIN, for example, JIS S35C, JIS S45C, JIS SCM440, JIS SCM420, JIS SCM415, JIS SCR440, JIS SCR420, MSB20, DEG, AG20, and the like can be objects to be treated. In addition, materials obtained by subjecting these materials to a carburization treatment, a carburization and nitrocarburization treatment, and a nitrocarburization treatment may also be objects to be treated.

In the lowering control step, it is sufficient that the support base is lowered into the coolant accumulated in the state of not flowing in the cooling tank, and the support base can be controlled so that the immersion of the object to be treated is completed and the support base is stopped while the vapor film of the coolant is formed around the object to be treated by the heat of the object to be treated. That is, in the lowering control step, the immersion may be completed before the vapor film disappears, and the support base may be stopped. The cooling tank is only required to be able to accumulate the coolant W in a state where the coolant W does not flow, and any shape, capacity, and the like can be used. Note that a device for applying an external force to the coolant W to cause the coolant W to flow may be installed or may not be installed. When the device is installed, the coolant W is caused to flow after the surface of the object to be treated undergoes martensite transformation, so that the object to be treated can be cooled early and taken out.

The coolant W may be any material that can form a vapor film around the object to be treated S. That is, the coolant W is only required to be a liquid in which heat conduction between the object to be treated S and the coolant Wis small due to the formation of the vapor film as compared with that in the boiling state. Such a coolant W is typically a liquid having a temperature zone in which the surface heat transfer coefficient between the object to be treated and the coolant W after immersion is flat (the change per unit temperature is equal to or less than a predetermined value) in the graph of the surface heat transfer coefficient and the temperature. As such a coolant W, for example, in addition to the above-described water-soluble coolant, various coolants W can be employed, and various aqueous solutions in which various materials are dissolved in water may be used, or quench oil may be used.

Further, when the vapor film stage shifts to the boiling stage, heat is transferred from the object to be treated to the coolant. In order to appropriately perform quenching, it is preferable that heat transfer in the boiling stage is fast. The degree of heat transfer can be evaluated by the surface heat transfer coefficient, and in order to appropriately perform quenching in the boiling stage, the maximum value of the surface heat transfer coefficient in the boiling stage is preferably 6000 W/m²·K or more. Since the surface heat transfer coefficient is the amount of heat per unit area and unit temperature when heat is transferred from the object to be treated to the coolant, rapid cooling can be performed as the surface heat transfer coefficient is large. It is known that, when the maximum value of the surface heat transfer coefficient in the boiling stage is 6000 W/m²·K or more, the cooling rate inside the object to be treated S is increased, martensite transformation is performed, and quenching for improving the internal hardness and the depth of the cured layer can be performed in a state where the coolant around the object to be treated is not caused to flow. Of course, the surface heat transfer coefficient is preferably larger, and the maximum value is more preferably 7000 W/m²·K or more and 8000 W/m²·K or more.

The support base for lowering the object to be treated may have various configurations. For example, as in the above-described embodiment, a support base on which the object to be treated is placed, a support base including a support portion that supports the object to be treated, an insertion portion that inserts the object to be treated, and the like may be used, or a basket-shaped support base through which the coolant W passes may be used. In addition, a support base that can fix the object to be treated with various fixing members may be used, and various other configurations can be used.

The vapor film is a film of vapor formed by transfer of heat of the object to be treated to the coolant W. That is, a state in which vapor is in direct contact with the object to be treated and a layer of vapor covering the object to be treated is formed is a state in which a vapor film is formed. The vapor film may inhibit direct contact between the object to be treated and the coolant W in a liquid state. A state in which the vapor film is formed is assumed to be a state in which vapor exists over the entire outer face of the object to be treated and the outer face of the object to be treated is not in contact with the liquid coolant W. The outer face of the object to be treated may be in contact with the liquid coolant W locally to such an extent that there is no influence on distortion.

The immersion may be a treatment of immersing the object to be treated in the coolant W. That is, the immersion may be considered to be completed when the entire object to be treated is immersed in the coolant W from the state where the coolant W does not exist around the object to be treated. The immersion is completed when the uppermost portion of the object to be treated is present below the liquid level of the coolant W. In order to complete the immersion in a state where the vapor film is formed, it is not necessary to lower the support base to an excessively deep position. For example, the support base may be lowered to such a depth that the uppermost portion of the object to be treated is not exposed above the liquid level of the coolant W due to the fluctuation of the liquid level.

The support base may be stopped as long as a state in which no relative flow velocity is generated between the object to be treated and the coolant W around the object to be treated is achieved in a state in which the support base is stopped. That is, it is only required to realize a state in which the object to be treated is also stopped by the support base being stopped inside the coolant W that does not flow and the relative flow velocity is not generated except for natural convection and the like.

The state maintaining step is a step of maintaining a state in which the coolant does not flow and a state in which the support base does not move so that a relative flow velocity is not applied between the object to be treated and the coolant W at least until the surface of the object to be treated undergoes martensite transformation after the lowering of the support base is stopped. That is, after completion of immersion, the object to be treated may be held in the coolant W so as not to move until the surface of the object to be treated undergoes martensite transformation.

The object to be treated is preferably supported by the support base by point contact or line contact. Even in the case of point contact or line contact, when the object to be treated is fixed to the support base by being supported or gripped at a plurality of (for example, three or more points) positions, a state in which a relative flow velocity is not applied between the object to be treated and the coolant W can be realized.

Note that a state in which a relative flow velocity is not applied between the object to be treated and the coolant W is maintained at least until the surface of the object to be treated undergoes martensite transformation from the start of immersion. The state in which the relative flow velocity is applied can be realized by a mechanism other than the device for lowering the support base of the object to be treated, for example, a mechanism for circulating the coolant W. When the coolant W does not flow by the mechanism until the surface of the object to be treated undergoes martensite transformation, a state in which a relative flow velocity is not applied between the object to be treated and the coolant W is maintained.

That is, in the lowering control step and the state maintaining step, the coolant W does not flow by the mechanism for causing the coolant W to flow, and does not flow unless a slight movement such as natural convection is regarded as flow. As described above, no external force is applied to the coolant W for the purpose of moving the coolant W until the surface of the object to be treated undergoes martensite transformation, and in this sense, the coolant W does not circulate in the cooling tank. However, the coolant W may move due to an external force not intended to move the coolant W. For example, there may be a case where the coolant W acquires a flow velocity of 0 or more as the object to be treated descends, or a case where the coolant W moves by natural convection. Such movement is not included in the movement of the coolant W by an external force.

After the surface of the object to be treated undergoes martensite transformation, the coolant W may be moved by an external force. When the coolant W moves, there may be a difference in cooling rate between the upper part and the lower part of the object to be treated.

Therefore, when the coolant W flows around the object to be treated in a state where the support base is stopped, a difference occurs in the cooling rate of the object to be treated, which may cause distortion. However, after the entire surface of the object to be treated undergoes martensite transformation, the object to be treated is hard, so that distortion is less likely to occur. For this reason, even when the coolant W moves by an external force after the entire surface of the object to be treated undergoes martensite transformation, distortion does not occur or the magnitude of distortion is small. Therefore, when the coolant W is moved after the martensite transformation, cooling is promoted, cooling of the object to be treated is completed early, and the object to be treated can be taken out to the outside of the coolant W.

Whether the surface of the object to be treated undergoes martensite transformation may be defined by various methods, and for example, may be defined by an elapsed period after immersion of the object to be treated is started. The elapsed period may be defined by, for example, the martensite fraction or the temperature of the surface of the object to be treated. For example, a criterion such as a martensite fraction of 21%, 28%, 50%, or 61% may be set, and a period until the martensite fraction reaches a statistically reference value may be identified.

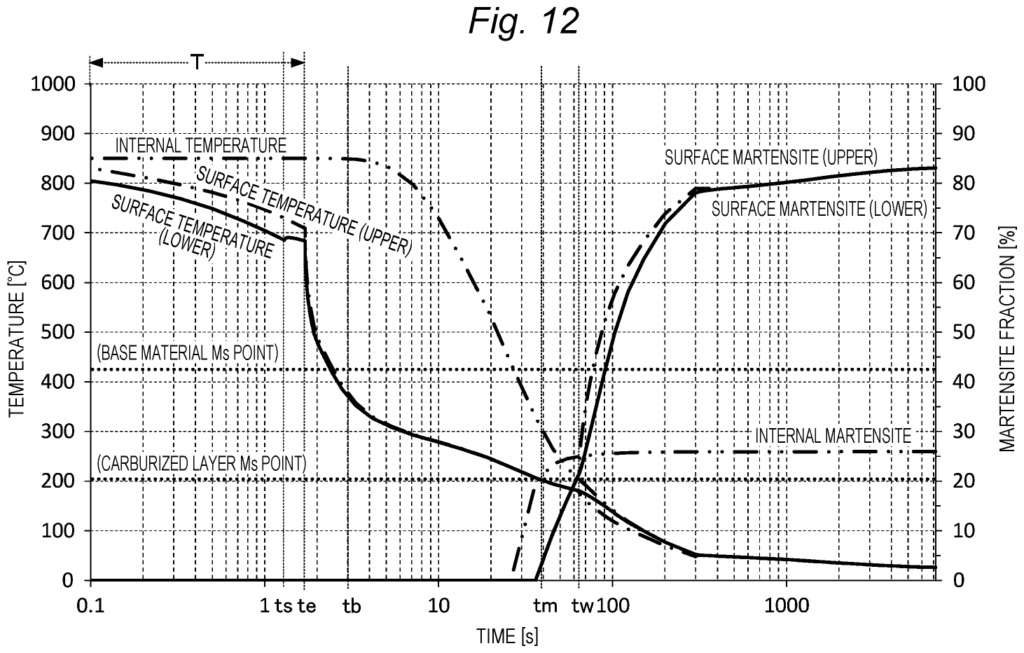

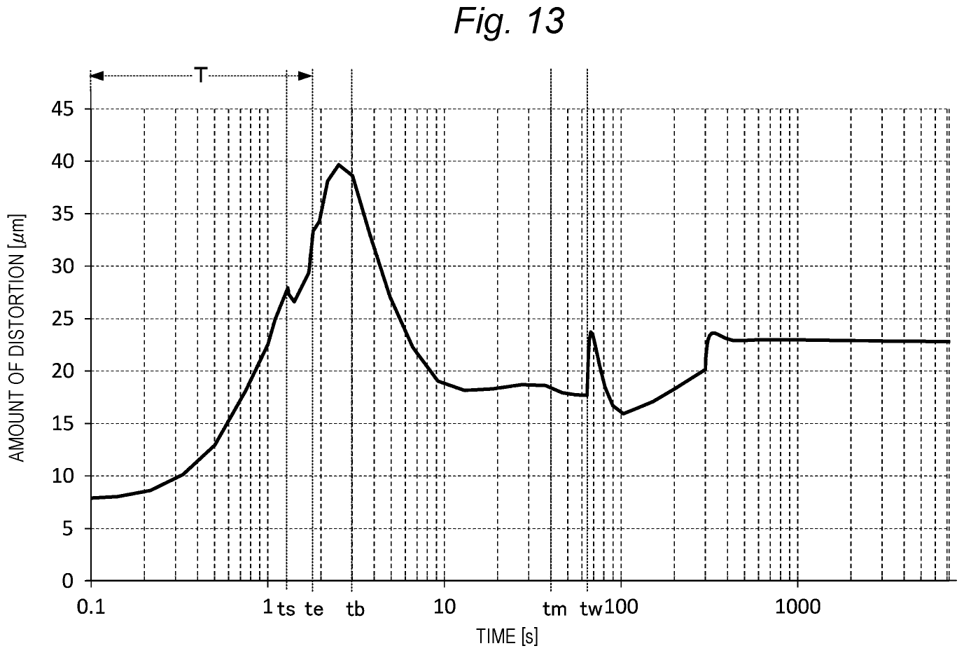

FIGS. 12 and 13 illustrate Example 2 in a case where a shaft similar to that in FIGS. 6 and 7 is immersed in the coolant W, and the coolant W is caused to flow after the martensite fraction reaches 21%. The notation of the graphs in FIGS. 12 and 13 is the same as that in FIGS. 6 and 7. In Example 2 illustrated in FIGS. 12 and 13, the coolant W is a 20% water-soluble coolant, and the temperature is room temperature (for example, 25° C.). The lowering speed of the support base 21 is 400 mm/s. Further, the flow velocity Vq of the coolant W is 0 mm/s until the martensite fraction reaches 21%, and the flow velocity Vq of the coolant W is 200 mm/s in the downward direction after the martensite fraction reaches 21%. The stroke ST is 520 mm, and the internal temperature of the object to be treated S at the start of immersion in the coolant Wis 850° C. The object to be treated S has been carburized with a surface layer of 3 mm at a face carbon concentration of 0.8 (mass %).

In Example 2 illustrated in FIGS. 12 and 13, the operation until the martensite fraction is 21% is substantially the same as that in Example 1 illustrated in FIGS. 6 and 7. Therefore, the transition of the surface temperature and the martensite fraction is the same as those in Examples illustrated in FIGS. 6 and 7 until the martensite fraction reaches 21%. When the surface temperature of the object to be treated S reaches the martensite transformation start temperature (denoted as a carburized layer Ms point in FIG. 12) at time tm, the martensite transformation proceeds. After time tm, the martensite fraction of the surface increases as illustrated in (upper) and (lower) of the surface martensite in FIG. 12.

When the martensite fraction reaches 21% at time tw, the flow of the coolant W is started. In the present Example, the flow velocity is 200 mm/s downward. When the flow velocity is generated around the object to be treated S, the temperature of the upper part of the object to be treated S is lower than that of the lower part after time tw. After time tw, the martensite fraction of the upper part of the object to be treated S is larger than that in the lower part. After time tw, the difference in temperature between the upper part and the lower part of the object to be treated S (the difference in the degree of thermal expansion) and the difference in the magnitude of the martensite fraction (the difference in the degree of expansion accompanying martensite transformation) are reflected, and the amount of distortion fluctuates after time tw as illustrated in FIG. 13, and finally converges to a constant value. In this example, since the flow of the coolant W is started when the martensite fraction is relatively low, distortion due to a difference in expansion associated with martensite transformation occurs, and the martensite transformation proceeds while the distortion is maintained, so that the distortion is large as compared with the case where there is no flow of the coolant in FIGS. 6 and 7, and the final value of the amount of distortion is about 23 μm. In a case where deformation is allowed, when the coolant W is caused to flow in this manner, the temperature of the object to be treated S can be lowered at an early stage as compared with a case where the coolant W is not caused to flow, and the object to be treated S can be taken out from the cooling tank 10 at an early stage.

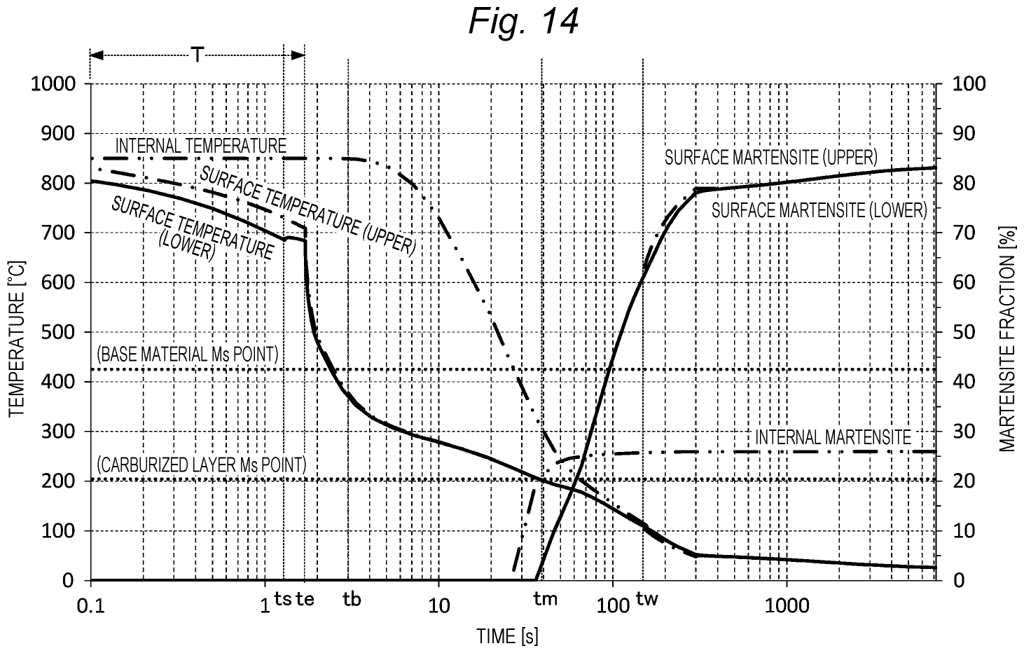

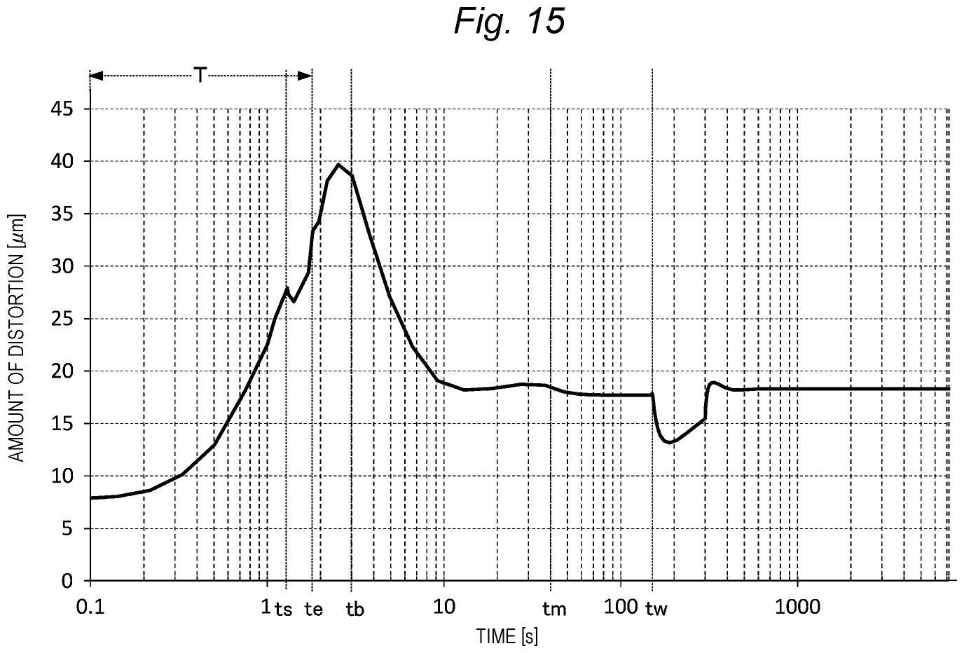

FIGS. 14 and 15 illustrate Example 3 in a case where a shaft similar to that in FIGS. 6 and 7 is immersed in the coolant W, and the coolant W is caused to flow after the martensite fraction reaches 61%. The notation of the graphs in FIGS. 14 and 15 is the same as that in FIGS. 6 and 7. Example 3 illustrated in FIGS. 14 and 15 is the same as Example 2 illustrated in FIGS. 12 and 13 except for the start timing of the flow of the coolant W by the flow unit.

When the martensite fraction reaches 61% at time tw, the flow of the coolant W is started. As a result, after time tw, the temperature of the upper part of the object to be treated S is lower than that of the lower part. After time tw, the martensite fraction of the upper part of the object to be treated S is larger than that in the lower part. After time tw, the difference in temperature between the upper part and the lower part of the object to be treated S (the difference in the degree of thermal expansion) and the difference in the magnitude of the martensite fraction (the difference in the degree of expansion accompanying martensite transformation) are reflected, and the amount of distortion fluctuates after time tw as illustrated in FIG. 15, and finally converges to a constant value. In this example, the final value of the amount of distortion is about 18 μm. In addition, after time tw at which the martensite fraction of the surface is 61%, even when the coolant W is caused to flow, the degree of distortion does not change from that in the case of not causing the coolant W to flow. Therefore, in the present embodiment, the coolant W can be caused to flow without being deteriorated to distortion after the martensite fraction is 61%, so that the temperature of the object to be treated S can be lowered earlier than in the case of not causing the coolant W to flow, and the object to be treated S can be taken out from the cooling tank 10 earlier.

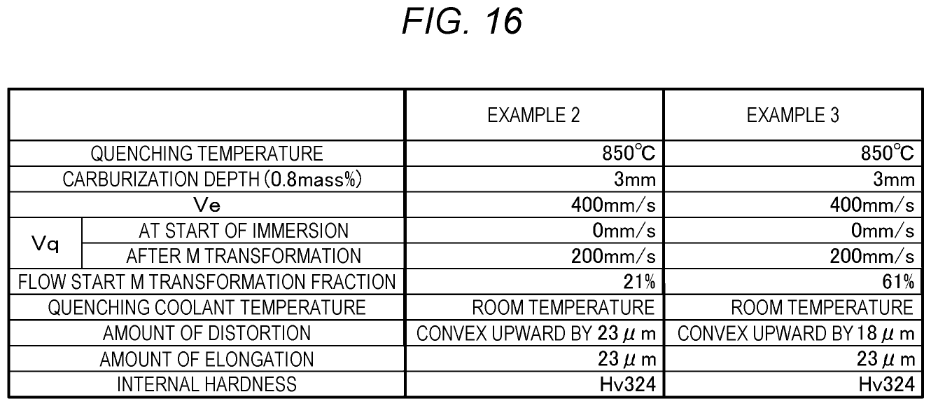

FIG. 16 illustrates the amount of distortion (bending amount) (μm), the amount of elongation (μm), and the internal hardness (Hv) of the object to be treated S in Example 2 and Example 3 as described above. The amount of distortion (bending amount) is defined as in FIGS. 7 and 9 described above. The amount of elongation and the internal hardness are defined in the same manner as in FIG. 10. When Example 2 and Example 3 are compared, the internal hardness and the amount of elongation are equivalent, but the amount of distortion is convex upward by 23 μm and convex upward by 18 μm, respectively. As described above, in Example 2, since the coolant W is cause to flow when the martensite fraction is low and before the martensite transformation sufficiently proceeds, the amount of distortion is larger than that in Example 3.

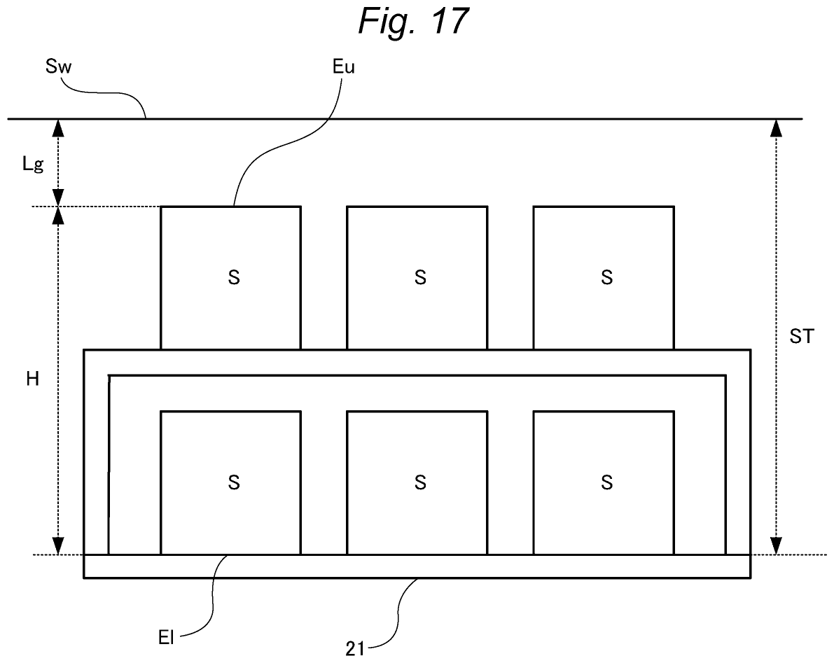

Further, a plurality of the objects to be treated S may be placed on the support base 21. The object to be treated S may be placed at each of a plurality of different positions in the vertical direction of the support base 21. FIG. 17 illustrates an Example in which the object to be treated S is placed at each of a plurality of different positions in the vertical direction of the support base 21. In the Example, the configuration other than the support base 21 and the object to be treated S placed on the support base 21 can be realized by the same configuration as the above-described embodiment.

In FIG. 17, a plurality of objects to be treated S can be placed on the support base 21 at two different positions in the vertical direction. Here, three objects to be treated S are placed on the lower step and three objects to be treated S are placed on the upper step of the support base 21. Of course, the objects to be treated S may be placed in the depth direction of the drawing. Here, the object to be treated S placed on the lower stage is referred to as a lowermost object to be treated S, and the object to be treated S placed on the upper stage is referred to as an uppermost object to be treated S. Of course, the objects to be treated S may be placed at positions in three or more stages in the vertical direction.

In the present Example, a state in which the upper end Eu of the uppermost object to be treated S is below the liquid level Sw of the coolant W is an immersion completion state. Also in the present embodiment, as illustrated in FIG. 17, the stroke ST is determined so that the upper end Eu of the uppermost object to be treated S is below the liquid level Sw of the coolant W by the predetermined distance Lg. That is, the stroke ST is set so that the distance Lg between the upper end Eu of the object to be treated S and the liquid level Sw of the coolant W is larger than 0. Note that it is not necessary to excessively increase the distance Lg, and the distance Lg may be the minimum necessary length. That is, the distance Lg may be set so that when the object to be treated S is not exposed to the outside of the coolant W, the lowering of the object to be treated S is stopped, and the uppermost portion of the object to be treated S is cooled at the position of the distance Lg from the liquid level Sw, the vapor film may be stably generated, and the coolant W covers the object to be treated S even in the boiling stage after the vapor film disappears. Specifically, the distance Lg can be set to a maximum waviness length (height)+30 mm or the like. The distance Lg may be set to one time or less, ½ or the like of the total height of the object to be treated S.

The lowering speed Ve may be set so that the immersion of the uppermost portion of the uppermost object to be treated S is completed while the vapor film of the coolant W is formed around the lowermost object to be treated S, and may be set in accordance with the height H from the lower end El of the lowermost object to be treated S to the upper end Eu of the uppermost object to be treated S, the characteristics of the coolant W, and the like. Specifically, in the present embodiment, lowering is performed until the distance (Lg+H) from the liquid level Sw of the coolant W to the lower end El of the lowermost object to be treated S at the descending stop position of the support base 21 matches the stroke ST. The lowering speed Ve is set to be higher than (the stroke ST/the vapor film maintaining period T around the lowermost object to be treated S).

When such a speed is set, immersion of all the objects to be treated S can be completed before the vapor film disappears. When the support base 21 is lowered at the lowering speed Ve and the distance from the liquid level Sw matches the stroke ST, the support base 21 is stopped. According to the above configuration, the immersion of the uppermost portion (upper end Eu) of the uppermost object to be treated S can be completed and the support base 21 can be stopped during the period in which the vapor film of the lowermost object to be treated S is formed. Then, at least until the surfaces of all the objects to be treated S undergo martensite transformation, a state in which a relative flow velocity is not applied between the object to be treated S and the coolant W is maintained.

According to this configuration, while the lowermost object to be treated S is covered with the vapor film, the movement of the objects to be treated S placed in a plurality of stages in the vertical direction is stopped. The coolant W around the object to be treated S does not flow until at least the surfaces of all the objects to be treated S undergo martensite transformation. Therefore, there is no factor that gives a relative flow velocity between the object to be treated S and the coolant W around all the objects to be treated S to be processed, and there is no factor that partially promotes cooling of the object to be treated S. Therefore, the possibility that a difference occurs in the cooling rate for each portion of all the objects to be treated S is reduced, and the possibility that the degree of progress of quenching is uneven can be reduced. In addition, a plurality of objects to be treated S can be quenched at once.

In the above-described embodiment, the vapor film maintaining period T is a period from when immersion of a portion of the object to be treated S immersed first is started to when the vapor film disappears and boiling starts around the portion. The vapor film maintaining period T is defined on the assumption that the periphery of the portion of the object to be treated S immersed first boils first, and this assumption holds for many components.

In addition, when there is a difference in ease of peeling of the vapor film around the object to be treated S for each portion of the object to be treated S, this assumption can be established so that the portion that is easily peeled is the lower end of the object to be treated S when immersion is performed. For example, when the object to be treated S includes portions having various shapes and has a sharp portion, the vapor film is more easily peeled off at the sharp portion than at the non-sharp portion. In this case, the object to be treated S may be placed on the support base 21 so that the pointed portion is the lower end. In addition, when there are many sharp portions in the object to be treated S, the sharp portions may be located at the lower end by orienting the object to be treated S so as to be easily placed on the support base 21.

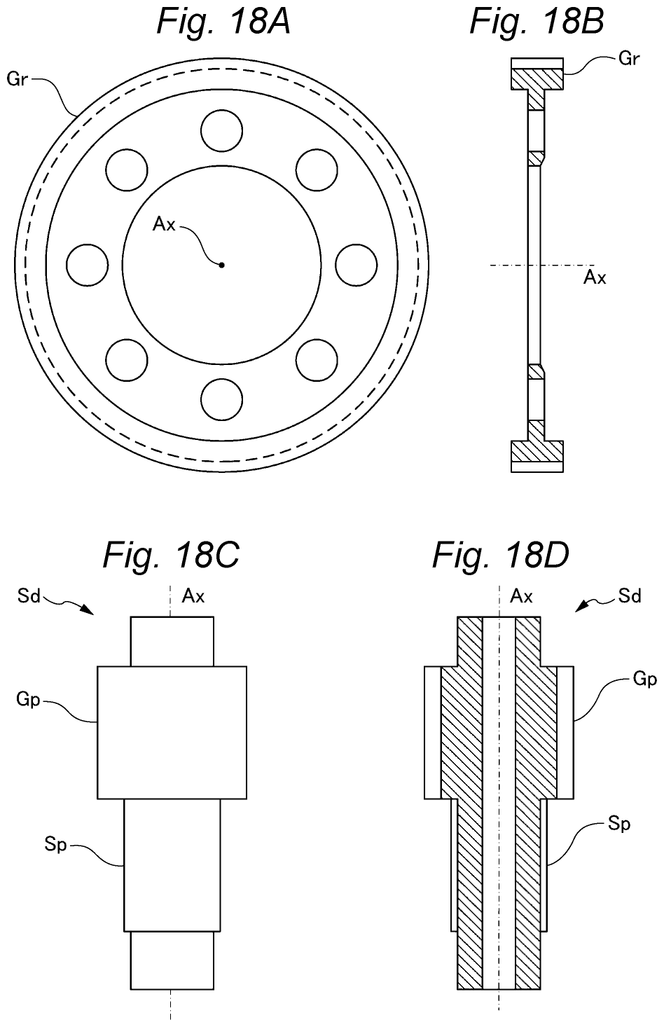

FIGS. 18A and 18B illustrate an Example of the object to be treated S having a large number of sharp portions. In the present Example, the object to be treated S is a ring gear Gr. The ring gear Gr is an annular component, FIG. 18A illustrates a state in which the ring gear Gr is viewed along the center axis Ax of the ring, and FIG. 18B is a cross-sectional view illustrating a state cut along a plane including the center axis Ax of the ring. Teeth that mesh with another gear are formed on an outer peripheral portion of the ring gear Gr. In FIG. 18A, a portion where teeth are formed is indicated by a broken line. The tooth portion of the ring gear Gr has a sharper tip than the other portions.

Therefore, when the ring gear Gr is placed on the support base 21 so that the center axis Ax is in the horizontal direction as illustrated in FIGS. 18A and 18B, the tooth portion exists at the lower end. Therefore, in this arrangement, the vapor film maintaining period T can be regarded as a period from when immersion of the portion immersed first of the object to be treated S is started to when the vapor film disappears and boiling starts around the portion.

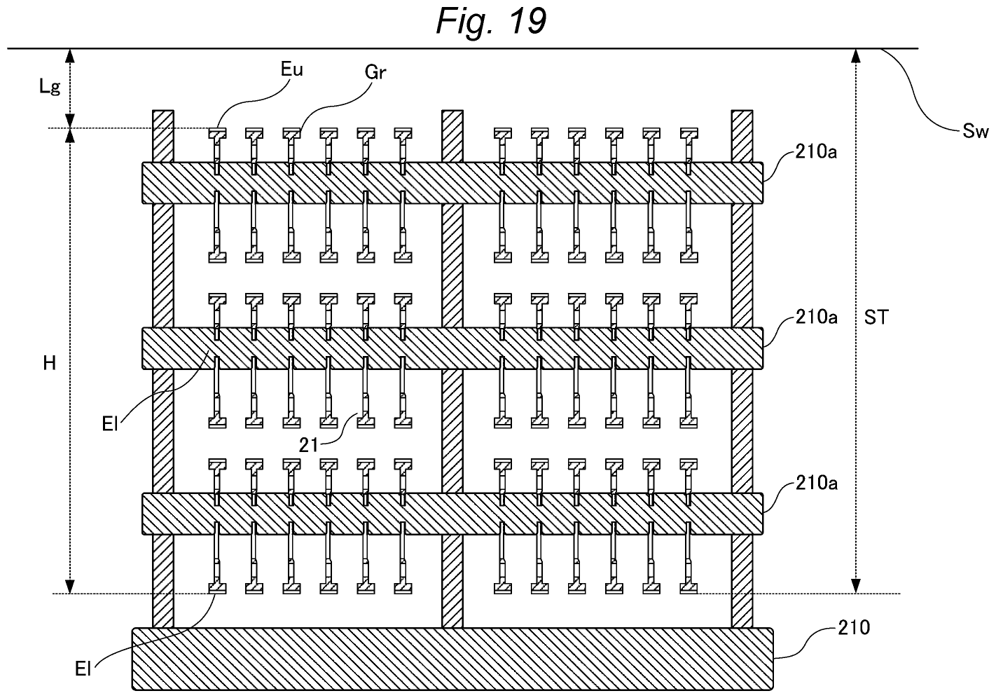

FIG. 19 is a diagram illustrating an example of a support base 210 when the ring gear Gr illustrated in FIGS. 18A and 18B is immersed. The support base 210 is a base on which the ring gears Gr can be placed at three stages in the vertical direction. FIG. 19 illustrates the ring gear Gr in a cross section similar to that of FIG. 18B, and illustrates a state in which the support base 210 is cut in the cross section.

The support base 210 includes a placement portion 210a on which the ring gear Gr is placed. The placement portions 210a can be attached to the support base 210 at three different places in the vertical direction. The placement portion 210a has recesses at a plurality of positions, and the inner peripheral face of the ring gear Gr can be hooked on and positioned with respect to each of the recesses. The placement portion 210a is set on the support base 210 in a state where the inner peripheral face of the ring gear Gr is hooked on each of the recesses. Of course, the object to be treated S may be placed in the depth direction of the drawing.

Also in this example, as illustrated in FIG. 19, the stroke ST is determined so that the upper end Eu of the uppermost object to be treated S below the liquid level Sw of the coolant W by the predetermined distance Lg. The object to be treated S descends until the distance (Lg+H) from the liquid level Sw of the coolant W to the lower end El of the lowermost object to be treated S at the descending stop position of the support base 210 matches the stroke ST. The lowering speed Ve is set to be higher than (the stroke ST/the vapor film maintaining period T around the lowermost object to be treated S).

When such a speed is set, immersion of all the objects to be treated S can be completed before the vapor film disappears. When the support base 210 is lowered at the lowering speed Ve and the distance from the liquid level Sw matches the stroke ST, the support base 210 is stopped. According to the above configuration, the immersion of the uppermost portion (upper end Eu) of the uppermost object to be treated S can be completed and the support base 210 can be stopped during the period in which the vapor film of the lowermost object to be treated S is formed. Then, at least until the surfaces of all the objects to be treated S undergo martensite transformation, a state in which a relative flow velocity is not applied between the object to be treated S and the coolant W is maintained.

According to this configuration, while the lowermost object to be treated S is covered with the vapor film, the movement of the objects to be treated S placed in a plurality of stages in the vertical direction is stopped. The coolant W around the object to be treated S does not flow until at least the surfaces of all the objects to be treated S undergo martensite transformation. Therefore, there is no factor that gives a relative flow velocity between the object to be treated S and the coolant W around all the objects to be treated S to be processed, and there is no factor that partially promotes cooling of the object to be treated S. Therefore, the possibility that a difference occurs in the cooling rate for each portion of all the objects to be treated S is reduced, and the possibility that the degree of progress of quenching is uneven can be reduced. In addition, a plurality of objects to be treated S can be quenched at once.

Further, when the periphery of the portion different from the portion immersed first shifts to the boiling stage first, the vapor film maintaining period T may be shorter. FIGS. 18C and 18D illustrate Examples of the object to be treated S in which a sharp portion locally exists. In the present Example, the object to be treated S is a drive shaft Sd. The drive shaft Sd is a substantially cylindrical component, FIG. 18C is a cross-sectional view illustrating a state in which the drive shaft Sd is viewed in a direction perpendicular to the center axis Ax, and FIG. 18D is a cross-sectional view illustrating a state cut along a plane including the center axis Ax of the ring. In the drive shaft Sd, a pinion gear portion Gp in which teeth meshing with other gears are formed in a circumferential direction around the center axis Ax, and a spline portion Sp in which teeth meshing with other components are formed are formed.

In FIG. 18C, details of teeth formed in the pinion gear portion Gp and the spline portion Sp are omitted. In the present Example, the tooth formed in the spline portion Sp is shorter than the tooth formed in the pinion gear portion Gp, and the tooth tip is not pointed. Therefore, in the drive shaft Sd according to the present Example, the vapor film is most likely to peel off around the tooth tip of the spline portion Sp. When the drive shaft Sd is placed on the support base 21 in the posture illustrated in FIGS. 18C and 18D, the pinion gear portion Gp shifts to the boiling stage earlier than the lower end where the immersion is started first. In this case, the vapor film maintaining period T is regarded as a period from when immersion of the object to be treated S is started to when a portion where the surrounding vapor film disappears and boiling starts occurs.

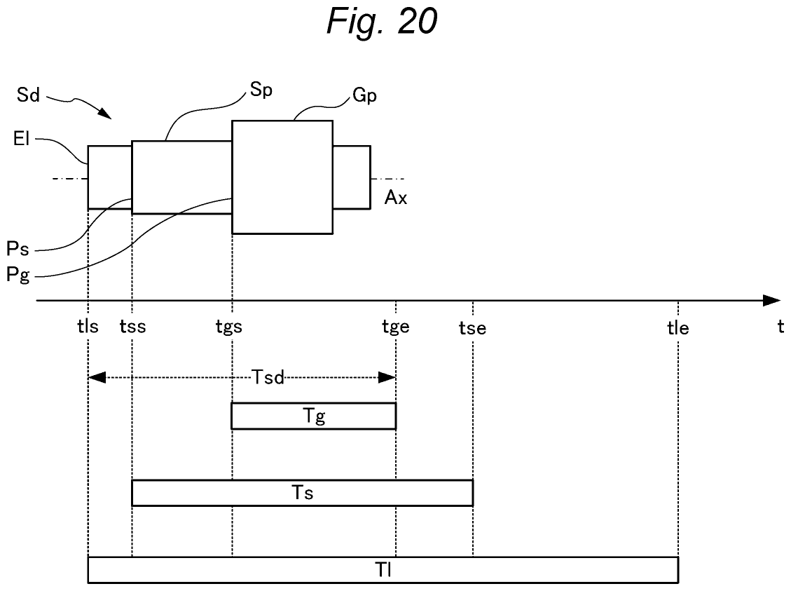

FIG. 20 is a schematic diagram for describing, for each part, a period during which the vapor film is maintained when the drive shaft Sd is immersed. FIG. 20 illustrates, for each part, a period during which the vapor film is maintained in a case where immersion is performed in the same direction as in FIGS. 18C and 18D, that is, in a state in which the spline portion Sp exists below the pinion gear portion Gp and the center axis Ax is in the vertical direction. In FIG. 20, periods TI, Ts, and Tg during which the vapor film is maintained along the time axis t are illustrated.

In FIG. 20, it is assumed that the support base 21 on which the drive shaft Sd is placed is lowered and the immersion of the lower end El is started at time tls. Subsequently, it is assumed that the immersion of the portion Ps is started at time tss and the immersion of the portion Pg is started at time tgs. When immersion is started, a vapor film is formed around each portion. In this example, the vapor film formed around the lower end El disappears at time tle, and the periphery of the lower end El shifts to the boiling stage after time tle. Further, the vapor film formed around a portion Ps disappears at time tse, and the periphery of a portion Ps shifts to the boiling stage after time tse. Further, the vapor film formed around the portion Pg disappears at time tge, and the periphery of the portion Pg shifts to the boiling stage after time tge.

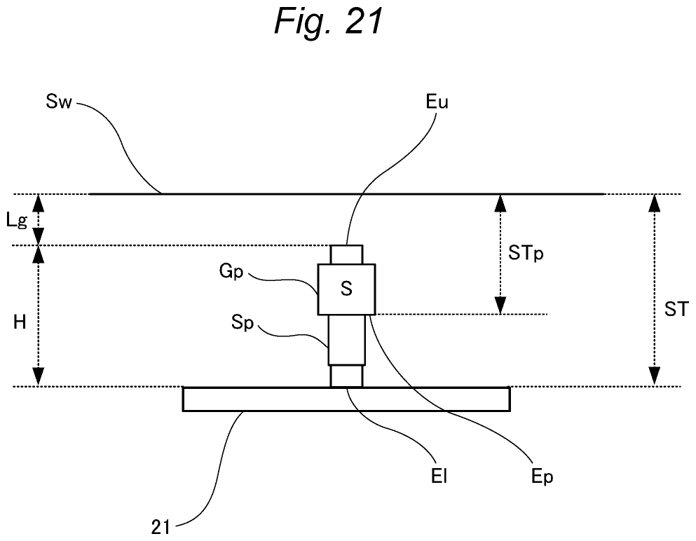

In this example, the vapor film around the portion Pg disappears earliest. In this case, the vapor film maintaining period T is a period from when immersion of the object to be treated S is stared to when the portion Pg where the surrounding vapor film disappears and boiling starts occurs, that is, the period Tsd from time tls to time tge. In this case, in the lowering control step, the support base 21 is controlled so that the immersion of the object to be treated S is completed and the support base 21 is stopped during the period Tsd. FIG. 21 is a diagram illustrating a state in which immersion is completed when the drive shaft Sd is used as the object to be treated S. FIG. 21 illustrates a state in which, in the support base 21, the object to be treated S is placed on the support base 21 with the spline portion Sp below the pinion gear portion Gp.

Also in this example, as illustrated in FIG. 21, the stroke ST is determined so that the upper end Eu of the object to be treated S is lower than the liquid level Sw of the coolant W by the predetermined distance Lg. The distance Lg may be set in the same manner as in the above example. The lowering speed Ve may be set so that the immersion of the object to be treated S is completed while the vapor film of the coolant W is formed around the pinion gear portion Gp, and may be set in accordance with the height H from the lower end El of the object to be treated S to the upper end Eu of the object to be treated S, the characteristics of the coolant W, and the like.

Specifically, in the present embodiment, the object to be treated S descends until the distance (Lg+H) from the liquid level Sw of the coolant W to the lower end El of the object to be treated S at the descending stop position of the support base 21 matches the stroke ST. When a stroke from the liquid level Sw to the lower end Ep of the pinion gear portion Gp, which is a portion where the vapor film is first peeled off, is defined as a stroke STp, and a period from when the lower end Ep of the pinion gear portion Gp is immersed to when the periphery of the lower end Ep shifts to the boiling stage is defined as the period Tg (see FIG. 20), the lowering speed Ve is set to be faster than STp/Tg.

When such a speed is set, the lower end Ep of the pinion gear portion Gp reaches the depth of the stroke STp faster than the time when the period Tg has elapsed since the immersion of the lower end Ep of the pinion gear portion Gp was started. Therefore, as illustrated in FIG. 20, in a state in which the condition that the portion where the vapor film disappears earliest is the portion Pg is satisfied, the immersion can be completed and the support base 21 can be stopped in a period in which the vapor film is maintained in any of the surroundings of the object to be treated S. At least until the surface of the object to be treated S undergoes martensite transformation, a state in which a relative flow velocity is not applied between the object to be treated S and the coolant W is maintained. According to this configuration, it is possible to reduce the possibility that a difference occurs in the cooling rate for each portion of the object to be treated S, and it is possible to reduce the possibility that the degree of progress of quenching is uneven.

The drive shaft Sd as the object to be treated S illustrated in FIGS. 18C and 18D is asymmetric in the vertical direction. Therefore, the distance of the stroke STp is different between the case where the spline portion Sp is located below the pinion gear portion Gp as illustrated in FIG. 21 and the case where the spline portion Sp is located vertically reversed, that is, the spline portion Sp is above the pinion gear portion Gp. Specifically, when the spline portion Sp is above the pinion gear portion Gp, the lower end of the pinion gear portion Gp exists at a position deeper than the state illustrated in FIG. 21. Therefore, the stroke STp to the lower end of the pinion gear portion Gp is deeper. In this state, the lower limit value STp/Tg of the lowering speed Ve is larger, and it is necessary to perform control faster.

Therefore, in the object to be treated S asymmetric in the vertical direction, the object to be treated S is preferably placed on the support base 21 so that a portion, of the object to be treated S, where the surrounding vapor film disappears the fastest and boiling starts faces upward in the vertical direction. According to this configuration, it is not necessary to excessively increase the lowering speed Ve as compared with the case where the object to be treated S is placed on the support base 21 in the opposite direction in the vertical direction, and the degree of freedom in designing the device for lowering the support base 21 is increased.

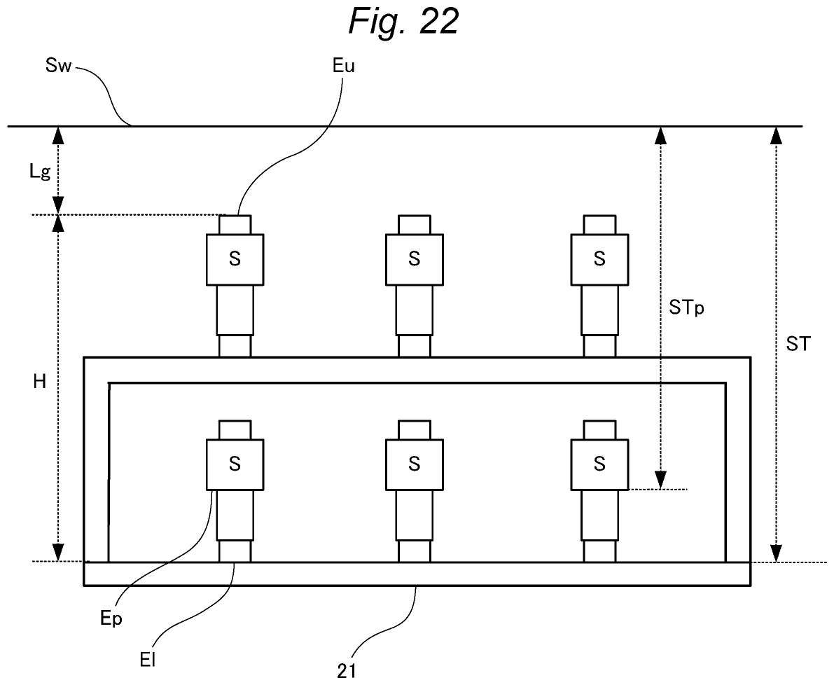

Furthermore, the object to be treated S may be placed at each of a plurality of different positions in the vertical direction of the support base 21. FIG. 22 illustrates an Example in which the drive shaft Sd as the object to be treated S is placed at each of a plurality of different positions in the vertical direction of the support base 21. In FIG. 22, a plurality of objects to be treated S can be placed on the support base 21 at two different positions in the vertical direction. The number of objects to be treated S to be disposed in the vertical direction and the horizontal direction may be any number, and the objects to be treated S may be mountable in the depth direction of the drawing.

In the present Example, a state in which the upper end Eu of the uppermost object to be treated S is below the liquid level Sw of the coolant W is an immersion completion state. Also in the present embodiment, as illustrated in FIG. 22, the stroke ST is determined so that the upper end Eu of the uppermost object to be treated S is below the liquid level Sw of the coolant W by the predetermined distance Lg. The distance Lg may be set in the same manner as in the above example. The lowering speed Ve may be set so that the immersion of the uppermost object to be treated S is completed while the vapor film of the coolant W is formed around the pinion gear portion Gp in the lowermost drive shaft Sd, and may be set in accordance with the height from the lower end Ep of the pinion gear portion Gp in the lowermost drive shaft Sd to the upper end Eu of the uppermost object to be treated S, the characteristics of the coolant W, and the like.

Specifically, in the present Example, lowering is performed until the distance (Lg+H) from the liquid level Sw of the coolant W to the lower end El of the lowermost object to be treated S at the descending stop position of the support base 21 matches the stroke ST. When a stroke from the liquid level Sw to the lower end Ep of the pinion gear portion Gp, which is a portion where the vapor film is first peeled off in the lowermost drive shaft Sd, is defined as the stroke STp, and a period from when the lower end Ep of the pinion gear portion Gp is immersed to when the periphery of the lower end Ep shifts to the boiling stage is defined as the period Tg (see FIG. 20), the lowering speed Ve is set to be faster than STp/Tg.

When such a speed is set, immersion of all the objects to be treated S can be completed before the vapor film of the lowermost object to be treated S disappears. When the support base 21 is lowered at the lowering speed Ve and the distance from the liquid level Sw matches the stroke ST, the support base 21 is stopped. According to the above configuration, the immersion of the uppermost portion (upper end Eu) of the uppermost object to be treated S can be completed and the support base 21 can be stopped during the period in which the vapor film of the lowermost object to be treated S is formed. Then, at least until the surfaces of all the objects to be treated S undergo martensite transformation, a state in which a relative flow velocity is not applied between the object to be treated S and the coolant W is maintained.

According to this configuration, while the lowermost object to be treated S is covered with the vapor film, the movement of the objects to be treated S placed in a plurality of stages in the vertical direction is stopped. At least the coolant W around the object to be treated S does not flow until the surfaces of all the objects to be treated undergo martensite transformation. Therefore, there is no factor that gives a relative flow velocity between the object to be treated S and the coolant W around all the objects to be treated S to be processed, and there is no factor that partially promotes cooling of the object to be treated S. Therefore, the possibility that a difference occurs in the cooling rate for each portion of all the objects to be treated S is reduced, and the possibility that the degree of progress of quenching is uneven can be reduced. In addition, a plurality of objects to be treated S can be quenched at once.

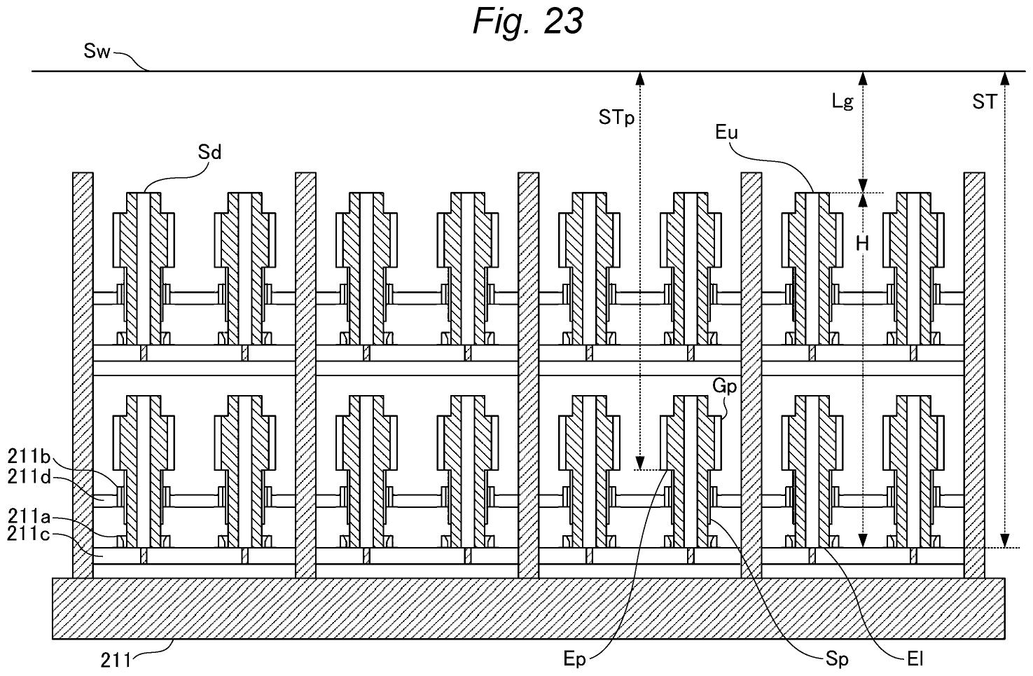

FIG. 23 is a diagram illustrating an example of a support base 211 when the drive shaft Sd illustrated in FIGS. 18C and 18D is immersed. The support base 211 is a base on which a plurality of drive shafts Sd can be placed at two stages in the vertical direction. In FIG. 23, the drive shaft Sd is illustrated in a cross section similar to that in FIG. 18D, and a state in which the support base 211 is cut in the cross section is illustrated.

The support base 211 includes insertion portions 211a and 211b into which the drive shaft Sd is inserted. The insertion portions 211a and 211b are members having inner peripheral faces slightly larger than the outer periphery at a plurality of locations (in the present Example, three locations.) on the outer periphery of the drive shaft Sd. These insertion portions 211a and 211b hold the drive shaft Sd in a state of being erected in the vertical direction in a state where the spline portion Sp of the drive shaft Sd is inserted.

In the present Example, the insertion portions 211a and 211b are formed at two different positions in the vertical direction with respect to one drive shaft Sd. In the present Example, the insertion portion 211a is coupled to a coupling portion 211c, and the coupling portion 211c extends in a predetermined direction and is coupled to another coupling portion 211c or a portion of the support base 211 extending in the vertical direction. The insertion portion 211b is connected to a coupling portion 211d, and the coupling portion 211d extends in a predetermined direction and is connected to another coupling portion 211d or a portion of the support base 211 extending in the vertical direction.

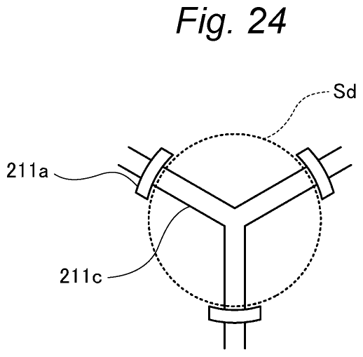

It is sufficient that the insertion portions 211a and 211b into which the drive shaft Sd is inserted can hold the drive shaft Sd, and the coupling portions 211c and 211d may support the insertion portions 211a and 211b. FIG. 24 illustrates a state in which the insertion portion 211a and the coupling portion 211c for inserting one drive shaft Sd are viewed in the center axis Ax direction of the drive shaft Sd. As illustrated in FIG. 24, the coupling portion 211c extends in three directions from a portion where the center of the drive shaft Sd is located, and the insertion portion 211a is formed in each of them. The coupling portion 211c is connected to another coupling portion 211c at a portion not illustrated.

Also in the Example illustrated in FIG. 23, lowering is performed until the distance (Lg+H) from the liquid level Sw of the coolant W to the lower end El of the lowermost object to be treated S at the descending stop position of the support base 21 matches the stroke ST. When a stroke from the liquid level Sw to the lower end Ep of the pinion gear portion Gp, which is a portion where the vapor film is first peeled off in the lowermost drive shaft Sd, is defined as the stroke STp, and a period from when the lower end Ep of the pinion gear portion Gp is immersed to when the periphery of the lower end Ep shifts to the boiling stage is defined as the period Tg (see FIG. 20), the lowering speed Ve is set to be faster than STp/Tg.

When such a speed is set, immersion of all the objects to be treated S can be completed before the vapor film of the lowermost object to be treated S disappears. When the support base 211 is lowered at the lowering speed Ve and the distance from the liquid level Sw matches the stroke ST, the support base 211 is stopped. According to the above configuration, the immersion of the uppermost portion (upper end Eu) of the uppermost object to be treated S can be completed and the support base 211 can be stopped during the period in which the vapor film of the lowermost object to be treated S is formed. Then, at least until the surfaces of all the objects to be treated S to be treated undergo martensite transformation, a state in which a relative flow velocity is not applied between the object to be treated S and the coolant W is maintained. According to this configuration, it is possible to reduce the possibility that a difference occurs in the cooling rate for each portion of the object to be treated S, and it is possible to reduce the possibility that the degree of progress of quenching is uneven. In addition, a plurality of objects to be treated S can be quenched at once.

A quenching method of cooling an object to be treated placed on a support base, the quenching method includes a lowering control step of controlling the support base so that the support base is lowered into a coolant accumulated in a state of the coolant not flowing in a cooling tank and having a maximum value of a surface heat transfer coefficient in a boiling stage of 6000 W/m²·K or more, and immersion of the object to be treated is completed and the support base is stopped while a vapor film of the coolant is formed around the object to be treated by heat of the object to be treated, and a state maintaining step of maintaining a state in which the coolant is not flowed and a state in which the support base does not move so that a relative flow velocity is not applied between the object to be treated and the coolant at least until a surface of the object to be treated undergoes martensite transformation after the lowering of the support base is stopped.

The coolant having a maximum value of surface heat transfer coefficient at the boiling stage of 6000 W/m²·K or more has a very high cooling capacity. Therefore, when the cooling in the boiling stage is started in the coolant, the cooling proceeds at a very high speed, the cooling rate of the inside of the object to be treated can be increased, and the internal hardness of the object to be treated and the depth of the cured layer can be secured. On the other hand, in a state where the coolant around the object to be treated flows in one direction, the flow velocity relative to the coolant is large upstream of the flow of the object to be treated, and the coolant easily accumulates downstream of the flow, and the relative flow velocity is small. Therefore, the cooling rate of the portion upstream of the flow is faster than that of the portion downstream. Specifically, in the case of a coolant having a very high cooling capacity, the difference in cooling rate is significant for each portion of the object to be treated. As a result, distortion occurs in the object to be treated after quenching.

Therefore, in order to prevent replacement of the coolant by the flow of the coolant, the object to be treated is immersed in the coolant accumulated in a state of the coolant not flowing in the cooling tank, the support base is stopped, and a state in which a relative flow velocity is not applied between the object to be treated and the coolant is maintained at least until the surface of the object to be treated undergoes martensite transformation. In this configuration, after the lowering of the object to be treated is stopped, no relative speed is generated between the object to be treated and the surrounding coolant. Therefore, the possibility that a difference occurs in the cooling rate for each portion of the object to be treated is reduced, the possibility that the degree of progress of quenching is uneven can be reduced, and heat treatment deformation can be reduced.

By maintaining a state in which a relative flow velocity is not applied between the object to be treated and the coolant at least until the surface of the object to be treated undergoes martensite transformation, it is possible to reduce a difference in expansion associated with the martensite transformation upstream and downstream of the object to be treated, which occurs when the relative flow velocity is applied, and to reduce distortion in the object to be treated after quenching. In order not to cause a difference in the relative flow velocity of the surrounding coolant for each portion of the object to be treated, it is important to advance quenching of the object to be treated in the coolant that does not flow. However, when the coolant is not caused to flow, a relative flow velocity occurs between the object to be treated and the coolant in the process of immersing the object to be treated in the liquid coolant. Therefore, the immersion of the object to be treated is completed and stopped while the object to be treated is covered with the vapor film. With this configuration, the immersion step of immersion into the non-flowing coolant, the step causing the relative flow velocity, can be completed during the vapor film stage in which the cooling rate is low, and the influence of the relative flow velocity in the immersion step can be minimized. Further, a deep cooling tank is not required.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A quenching method of cooling an object to be treated placed on a support base, the quenching method comprising:
a lowering control step of controlling the support base so that the support base is lowered into a coolant accumulated in a state of the coolant not flowing in a cooling tank and having a maximum value of a surface heat transfer coefficient in a boiling stage of 6000 W/m²·K or more, and immersion of the object to be treated is completed and the support base is stopped while a vapor film of the coolant is formed around the object to be treated by heat of the object to be treated; and
a state maintaining step of maintaining a state in which the coolant does not flow and a state in which the support base does not move so that a relative flow velocity is not applied between the object to be treated and the coolant at least until a surface of the object to be treated undergoes martensite transformation after the lowering of the support base is stopped.

2. The quenching method according to claim 1, wherein
the coolant
has a boiling start temperature at which a vapor film formed around the object to be treated disappears and boiling starts of 600° C. or lower.

3. The quenching method according to claim 2, wherein
the coolant
has a boiling start temperature at which a vapor film formed around the object to be treated disappears and boiling starts of 450° C. or higher.

4. The quenching method according to claim 1, wherein
the coolant
has a rate of increase in a surface heat transfer coefficient per unit temperature decrease after a vapor film formed around the object to be treated disappears and boiling starts of 100 W/m²· K² or more.

5. The quenching method according to claim 1, wherein
the coolant includes a water-soluble coolant in which a polymer compound is dissolved in water.

6. The quenching method according to claim 5, wherein
the polymer compound includes at least one of polyalkylene glycol, polyvinyl alcohol, polyethylene glycol, sodium polyacrylate, and polyvinylpyrrolidone, and wherein
the coolant includes a water-soluble coolant in which 5 vol % to 30 vol % of the polymer compound is dissolved in water.

7. The quenching method according to claim 1, wherein
a period during which the vapor film is formed
is a period from when immersion of a portion immersed first of the object to be treated is started to when a vapor film disappears and boiling starts around the portion.

8. The quenching method according to claim 1, wherein
a period during which the vapor film is formed
is a period from when immersion of the object to be treated is started to when a portion where a surrounding vapor film disappears and boiling starts occurs.

9. The quenching method according to claim 1, wherein
a period during which the vapor film is formed
is a period in which an amount of change of a surface heat transfer coefficient between the coolant and the object to be treated with respect to an amount of decrease in temperature reaches a predetermined value or less first and then exceeds the predetermined value in a process in which the object to be treated is immersed in the coolant and temperature decreases.

10. The quenching method according to claim 1, wherein
a lowering speed of the object to be treated in the lowering control step
is faster than a distance from a liquid level of the coolant to a lower end of the object to be treated at a descending stop position/a period during which the vapor film is formed.

11. The quenching method according to claim 1, wherein
a surface of the object to be treated is regarded to have undergone martensite transformation when a martensite fraction of the surface of the object to be treated reaches a predetermined value.

12. The quenching method according to claim 1, wherein
the surface of the object to be treated is regarded to have undergone martensite transformation when a predetermined period has elapsed since immersion of the object to be treated was started.

13. The quenching method according to claim 1, wherein
a state in which a relative flow velocity is not applied between the object to be treated and the coolant
is a state in which the coolant is not moved by an external force, and the support base is not moved.
